(19) United States
(12) Patent Application Publication
(10) Pub. No.: US 2010/0020338 A1
(43) Pub. Date: Jan. 28, 2010

(54) PRINTING APPARATUS, CONTROL METHOD, AND STORAGE MEDIUM

(75) Inventor: Hitoshi Imai, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/754,918

(22) Filed: May 29, 2007

(30) Foreign Application Priority Data
Jun. 16, 2006 (JP) 2006-168120

(51) Int. Cl. H04N 1/60

(52) U.S. Cl. 358/1.9

(57) ABSTRACT

A printing apparatus determines the resolution of bitmap copy-forgery-inhibited pattern image data included in transmitted print data, and decides whether to print the bitmap copy-forgery-inhibited pattern image data onto a sheet based on the determination result.

### BACKGROUND OF THE INVENTION

1. Field of the Invention

The present invention relates to a printing apparatus, a control method, and a storage medium for printing on a sheet based on print data transmitted from an information processing apparatus.

2. Description of the Related Art

Japanese Patent Laid-Open No. 2005-198250(US-2005-0190411) discloses magnifying and reducing size of a copy-forgery-inhibited pattern image. This patent application discloses extracting a character string such as void and judging the size of dot in the copy-forgery-inhibited pattern image, then this application magnifies or reduces the size of the character string, and this application arranges dots whose size is same as the judged size in the character string.

However, it is too complicated technology to implement because it needs the processing of extracting a character string and judging dot size and arranging dots.

### SUMMARY OF THE INVENTION

The present invention provides a printing apparatus, a control method, and a storage medium that can print a copy-forgery-inhibited pattern image to be printed on a sheet while guaranteeing image quality.

A printing apparatus according to an aspect of the present invention includes a printing unit, a determination unit adapted to determine whether a print resolution of the printing unit is greater than or equal to a resolution of bitmap image data included in print data received from another apparatus, and a control unit adapted to permit printing by the printing unit of the bitmap image data included in the print data if it is determined by the determination unit that the print resolution of the printing unit is greater than or equal to the resolution of the bitmap image data, and interrupt or terminate printing by the printing unit of the bitmap image data included in the print data if it is determined by the determination unit that the print resolution of the printing unit is less than the resolution of the bitmap image data.

A printing apparatus according to another aspect of the present invention includes a printing unit, a reception unit adapted to receive bitmap copy-forgery-inhibited pattern image data and document image data from another apparatus, a determination unit adapted to determine whether a print resolution of the printing unit is greater than or equal to a resolution of the bitmap copy-forgery-inhibited pattern image data received by the reception unit, and a control unit adapted to permit printing by the printing unit of composite image data obtained by synthesizing the bitmap copy-forgery-inhibited pattern image data and the document image data if it is determined by the determination unit that the print resolution of the printing unit is greater than or equal to the resolution of the bitmap copy-forgery-inhibited pattern image data, and interrupt or terminate printing by the printing unit of composite image data obtained by synthesizing the bitmap copy-forgery-inhibited pattern image data and the document image data if it is determined by the determination unit that the print resolution of the printing unit is less than the resolution of the bitmap copy-forgery-inhibited pattern image data.

A printing apparatus according to still another aspect of the present invention includes a printing unit, a determination unit adapted to determine whether a print resolution of the printing unit is a positive integer multiple of a resolution of bitmap image data included in print data received from another apparatus, and a control unit adapted to permit printing by the printing unit of the bitmap image data included in the print data if it is determined by the determination unit that the print resolution of the printing unit is a positive integer multiple of the resolution of the bitmap image data, and interrupt or terminate printing by the printing unit of the bitmap image data included in the print data if it is determined by the determination unit that the print resolution of the printing unit is not a positive integer multiple of the resolution of the bitmap image data.

A method according to yet another aspect of the present invention for a printing apparatus having a printing unit, the method includes determining whether a print resolution of the printing unit is greater than or equal to a resolution of bitmap image data included in print data received from another apparatus, and permitting printing by the printing unit of the bitmap image data included in the print data if it is determined that the print resolution of the printing unit is greater than or equal to the resolution of the bitmap image data, and interrupting or terminating printing by the printing unit of the bitmap image data included in the print data if it is determined that the print resolution of the printing unit is less than the resolution of the bitmap image data.

A method according to yet still another aspect of the present invention for a printing apparatus having a printing unit, the method includes receiving bitmap copy-forgery-inhibited pattern image data and document image data from another apparatus, determining whether a print resolution of the printing unit is greater than or equal to a resolution of the bitmap copy-forgery-inhibited pattern image data received, and permitting printing by the printing unit of composite image data obtained by synthesizing the bitmap copy-forgery-inhibited pattern image data and the document image data if it is determined that the print resolution of the printing unit is greater than or equal to the resolution of the bitmap copy-forgery-inhibited pattern image data, and interrupting or terminating printing by the printing unit of composite image data obtained by synthesizing the bitmap copy-forgery-inhibited pattern image data and the document image data if it is determined that the print resolution of the printing unit is less than the resolution of the bitmap copy-forgery-inhibited pattern image data.

A method according to still yet another aspect of the present invention for a printing apparatus having a printing unit, the method includes determining whether a print resolution of the printing unit is a positive integer multiple of a resolution of bitmap image data included in print data received from another apparatus, and permitting printing by the printing unit of the bitmap image data included in the print data if it is determined that the print resolution of the printing unit is a positive integer multiple of the resolution of the bitmap image data, and interrupting or terminating printing by the printing unit of the bitmap image data included in the print data if it is determined that the print resolution of the printing unit is not a positive integer multiple of the resolution of the bitmap image data.

A storage medium according to yet still another aspect of the present invention characterized by storing, in a computer-readable form, a computer program that realizes a method for a printing apparatus having a printing unit, wherein the computer program causes a computer to execute a determination step of determining whether a print resolution of the printing unit is greater than or equal to a resolution of bitmap image data included in print data received from another apparatus, and a control step of permitting printing by the printing unit of the bitmap image data included in the print data if it is determined that the print resolution of the printing unit is greater than or equal to the resolution of the bitmap image data, and interrupting or terminating printing by the printing unit of the bitmap image data included in the print data if it is determined that the print resolution of the printing unit is less than the resolution of the bitmap image data.

A storage medium according to still yet another aspect of the present invention characterized by storing, in a computer-readable form, a computer program that realizes a method for a printing apparatus having a printing unit, wherein the computer program causes a computer to execute a reception step of receiving bitmap copy-forgery-inhibited pattern image data and document image data from another apparatus, a determination step of determining whether a print resolution of the printing unit is greater than or equal to a resolution of the bitmap copy-forgery-inhibited pattern image data received by the reception step, and a control step of permitting printing by the printing unit of composite image data obtained by synthesizing the bitmap copy-forgery-inhibited pattern image data and the document image data if it is determined that the print resolution of the printing unit is greater than or equal to the resolution of the bitmap copy-forgery-inhibited pattern image data, and interrupting or terminating printing by the printing unit of composite image data obtained by synthesizing the bitmap copy-forgery-inhibited pattern image data and the document image data if it is determined that the print resolution of the printing unit is less than the resolution of the bitmap copy-forgery-inhibited pattern image data.

A storage medium according to yet still another aspect of the present invention characterized storing, in a computer-readable form, a computer program that realizes a method for a printing apparatus having a printing unit, wherein the computer program causes a computer to execute a determination step of determining whether a print resolution of the printing unit is a positive integer multiple of a resolution of bitmap image data included in print data received from another apparatus, and a control step of permitting printing by the printing unit of the bitmap image data included in the print data if it is determined that the print resolution of the printing unit is a positive integer multiple of the resolution of the bitmap image data, and interrupting or terminating printing by the printing unit of the bitmap image data included in the print data if it is determined that the print resolution of the printing unit is not a positive integer multiple of the resolution of the pattern image data.

Further features of the present invention will become apparent from the following description of exemplary embodiments with reference to the attached drawings.

### BRIEF DESCRIPTION OF THE DRAWINGS

FIG. 1 shows the configuration of a printing system according to exemplary embodiments of the present invention.

FIG. 2 is a cross-sectional view showing the configuration of a tandem color LBP, which is an exemplary printing apparatus.

FIG. 3A shows the functional configuration of an information processing apparatus.

FIG. 3B is a block diagram showing the configuration of a printer controller of the printing apparatus.

FIG. 4 is a flowchart showing a basic process executed by the information processing apparatus of the printing system.

FIG. 5 is a flowchart showing a basic process executed by the printing apparatus of the printing system.

FIG. 6 is a view illustrating an exemplary process of the printing system.

FIG. 7 is a flowchart showing a print data generation process of the information processing apparatus.

FIG. 8 is a flowchart showing a printing process of the printing apparatus.

FIG. 9 is a view illustrating an exemplary process of the printing system.

FIG. 10 is a flowchart showing a print data generation process of the information processing apparatus.

FIG. 11 is a flowchart showing a printing process of the printing apparatus.

FIG. 12 is a flowchart showing a print data retransmission process of the information processing apparatus.

FIG. 13 is a view illustrating a process of the printing system.

FIG. 14 is a flowchart showing a print data generation process of the information processing apparatus.

FIG. 15 is a flowchart showing a printing process of the printing apparatus.

FIGS. 16A to 16F are views illustrating copy-forgery-inhibited pattern image data.

FIGS. 17A to 17F are views illustrating exemplary printouts of copy-forgery-inhibited pattern images.

FIG. 18 is a view illustrating cases where the process is switched depending on whether or not the print resolution is a positive integer multiple of the resolution of bitmap copy-forgery-inhibited pattern image data.

### DESCRIPTION OF THE EMBODIMENTS

A description will be given of exemplary embodiments of the present invention with reference to the accompanying drawings. In each figure, the same reference numeral denotes the same element. Therefore, duplicate description will not be provided.

### <Reason for Converting Resolution>

A printer driver loaded on an information processing apparatus, such as a host computer connected to a printer, is a module for generating print data. Printer driver developers basically develop a printer driver for every model of printer.

For example, a printer driver for generating print data to be transmitted to a printer A (model A) is developed as a printer driver A, while a printer driver for generating print data to be transmitted to a printer B (model B) is developed as a printer driver B.

However, even if the printer driver A transmits print data to the printer B, the printer B is still able to print the print data from the printer driver A. This is because printer driver developers develop printer drivers so that the individual printer drivers have compatibility.

Here, consider a case where a resolution of the printer A is 600 dpi, and a resolution of the printer B is 1200 dpi. In this case, the printer driver A generates 600 dpi print data, while the printer driver B generates 1200 dpi print data.

Consequently, when the printer B receives 600 dpi print data from the printer driver A, the printer B must convert the 600 dpi print data to 1200 dpi bitmap data before printing on a sheet. Similarly, when the printer A receives 1200 dpi print data from the printer driver B, the printer A must convert the 1200 dpi print data to 600 dpi bitmap data before printing on a sheet.

Thus, a high resolution printer that receives low resolution print data from a low resolution printer driver needs to convert the resolution. Similarly, a low resolution printer that receives high resolution print data from a high resolution printer driver needs to convert the resolution.

However, resolution conversion may cause problems where the print data includes particular image data, such as bitmap copy-forgery-inhibited pattern image data.

### <Bitmap Copy-Forgery-Inhibited Pattern Image Data>

A description will be given of bitmap copy-forgery-inhibited pattern image data.

An image is “a picture that exists on a sheet (recording medium, printing medium, or printing paper) or a display screen (in a visible shape or form)”

Bitmap image data is constituted by the color data and density data of a plurality of minute dots (pixels). Bitmap image data also includes data in a compressed state (JPEG image data, etc.).

A copy-forgery-inhibited pattern image is said to exist on a sheet if a latent image exists in one area of a sheet and a background image exists in the remaining area of the sheet. The area containing the latent image is called the latent image area, while the remaining area is called the background area.

Here, a reflection density of the latent image on the sheet and a reflection density of the background image on the sheet are approximately the same. However, the reflection density of the latent image, in the case of a copy that is obtained when the sheet is copied using a copy machine, is greater than the reflection density of the background image. The two images in this relation are respectively called the latent image and the background image. As described later, the background image is constituted by a large number of small dots (approximately 42 um×42 um or 21 um×21 um), while the latent image is constituted by a small number of large dots (approximately 126 um×126 um).

Each copy machine has its own particular reproduction capability. With any copy machine, the smaller the dots on a sheet, the more difficult it is to reproduce the dots in a copy that is obtained when the sheet is copied.

The background image constituted by small dots is thus difficult to reproduce when a sheet that contains a copy-forgery-inhibited pattern image is copied with a copy machine. On the other hand, the latent image constituted by large dots is easily reproduced. That is, even though the reflection densities of the latent image and the background image on the sheet are approximately the same, the reflection density of the latent image in the copy is greater than the reflection density of the background image.

A copy-forgery-inhibited pattern image makes use of this phenomenon. When a copy is made from an original copy of a certificate of residence or the like obtained at a government office, “INVALID” or a similar character string is reproduced. This is because the original copy of a certificate of residence contains a copy-forgery-inhibited pattern image.

Bitmap copy-forgery-inhibited pattern image data is used to create a sheet having a copy-forgery-inhibited pattern image. A sheet with a copy-forgery-inhibited pattern image can be created by printing the bitmap copy-forgery-inhibited pattern image data onto the sheet.

### <Bitmap Copy-Forgery-Inhibited Pattern Image Data in Detail>

Bitmap copy-forgery-inhibited pattern image data includes bitmap latent image data and bitmap background image data. Bitmap latent image data is constituted by disposing a plurality of pieces of bitmap latent image pattern data (described later). Bitmap latent image data corresponds to the latent image area. Similarly, bitmap background image data is constituted by disposing a plurality of pieces of bitmap background pattern data (described later). Bitmap background image data corresponds to the background area.

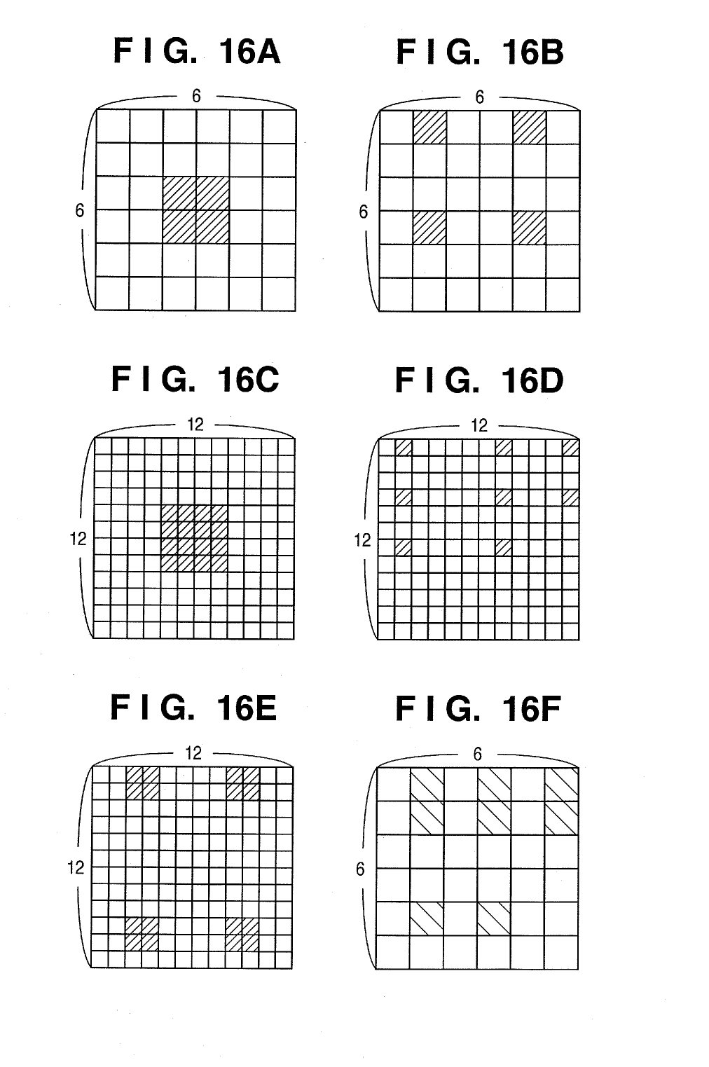

FIG. 16A shows bitmap latent image pattern data for black bitmap copy-forgery-inhibited pattern image data. In FIG. 16A, a pixel value of a black pixel when expressed by 8 bits is (R, G, B)=(0, 0, 0) or (C, M, Y, K)=(0, 0, 0, 255). On the other hand, a pixel value of a white pixel when expressed by 8 bits is (R, G, B)=(255, 255, 255) or (C, M, Y, K)=(0, 0, 0, 0). FIG. 16B shows bitmap background pattern data for black bitmap copy-forgery-inhibited pattern image data.

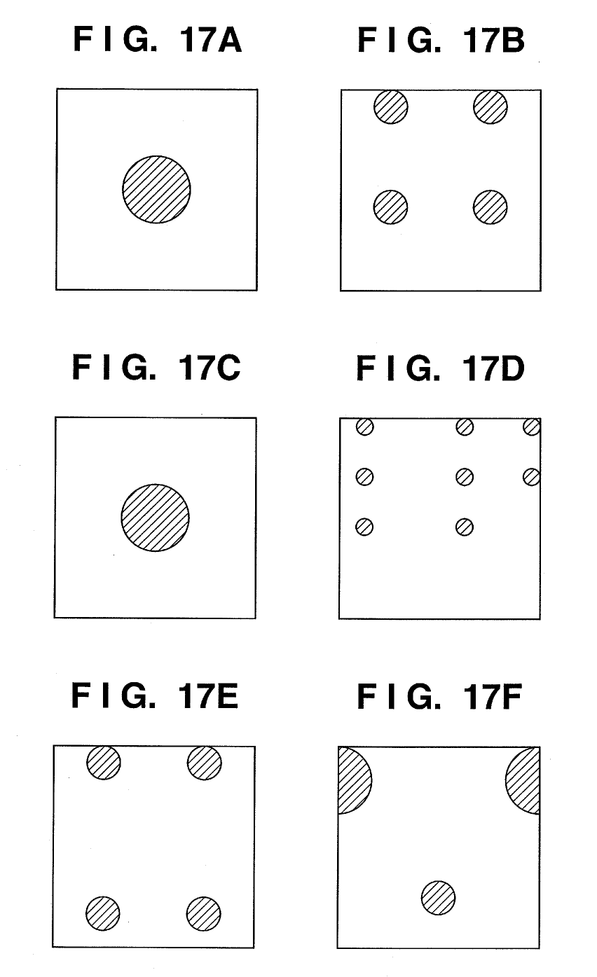

FIG. 17A is a latent image pattern obtained when the bitmap latent image pattern data shown in FIG. 16A is printed on a sheet. FIG. 17B is a background pattern obtained when the bitmap background pattern data shown in FIG. 16B is printed on a sheet.

In FIGS. 16A and 16B, a size of a single pixel shown by one rectangular area is approximately 42 um×42 um (600 dpi). In other words, the bitmap latent image pattern data shown in FIG. 16A and the bitmap background pattern data shown in FIG. 16B is bitmap image data for a 600 dpi printing apparatus. Black, cyan, magenta and yellow are the colors available for bitmap copy-forgery-inhibited pattern image data. The bitmap copy-forgery-inhibited pattern image data for each color is constituted by information ranging from 0 to 255 (binary data indicating whether or not to print a dot).

The bitmap latent image pattern data shown in FIG. 16C and the bitmap background pattern data shown in FIG. 16D is bitmap image data for a 1200 dpi printing apparatus. Referring to FIGS. 16B and 16D, the individual rectangles expressing single pixels are smaller in the case of the bitmap background pattern data for the 1200 dpi printing apparatus than in the case of the bitmap background pattern data for the 600 dpi printing apparatus. Consequently, the size of the dots when printed on a sheet as (without converting the resolution to a coarse image) is smaller.

FIG. 17C is a latent image pattern obtained when the bitmap latent image pattern data shown in FIG. 16C is printed on a sheet. FIG. 17D is a background pattern obtained when the bitmap background pattern data shown in FIG. 16D is printed on a sheet. As above-mentioned, the smaller the size of the dots, the more difficult it is to reproduce the dots when a copy is made, thus making 1200 dpi bitmap background pattern data preferable to 600 dpi bitmap background pattern data.

### <Reason For Not Converting the Resolution of Bitmap Copy-Forgery-Inhibited Pattern Image Data to Coarse Image Resolution>

Consider the case where the resolution of bitmap copy-forgery-inhibited pattern image data for the 600 dpi printing apparatus is simply converted to 1200 dpi (to a fine image resolution). Note that in the present embodiment, the 600 dpi printing apparatus is a printing apparatus that includes a printing unit with print resolution of 600 dpi. In this case, the 600 dpi bitmap latent image pattern data shown in FIG. 16A is converted to the 1200 dpi bitmap latent image pattern data shown in FIG. 16C. Also, the 600 dpi bitmap background pattern data shown in FIG. 16B is converted to the 1200 dpi bitmap background pattern data shown in FIG. 16E. As a result, the dot shown in FIG. 17C is disposed in the latent image area of the copy-forgery-inhibited pattern image formed on the sheet, and the dots shown in FIG. 17E are disposed in the background area. Consequently, the effect of the copy-forgery-inhibited pattern image formed on the sheet is maintained.

On the other hand, consider the case where the resolution of bitmap copy-forgery-inhibited pattern image data for the 1200 dpi printing apparatus is simply converted to 600 dpi (resolution conversion to a coarse image). In this case, the 1200 dpi bitmap latent image pattern data shown in FIG. 16C is converted to the 600 dpi bitmap latent image pattern data shown in FIG. 16A. Also, the 1200 dpi bitmap background pattern data shown in FIG. 16D is converted to the 600 dpi bitmap background pattern data shown in FIG. 16F.

This conversion involves black pixels in the 1200 dpi bitmap background pattern data being converted to 600 dpi bitmap background pattern data together with adjacent white pixels, for example. Consequently, the pixel value of black pixels in the 600 dpi bitmap background pattern data is below the pixel value of black pixels in the corresponding 1200 dpi bitmap background pattern data. While also dependent on the conversion method, the pixel value of black pixels in the 600 dpi bitmap background pattern data will, for example, be 50% of the pixel value of the black pixels of the corresponding 1200 dpi bitmap background pattern data.

As a result, the dot shown in FIG. 17A is disposed in the latent image area of the copy-forgery-inhibited pattern image formed on the sheet, and the dots shown in FIG. 17F are disposed in the background area. The dots shown in FIG. 17F, however, result from binarizing the data shown in FIG. 16F and printing. Referring to FIG. 17F, dots larger than the small dots that were to be disposed in the background area end up being disposed. The density of the background image in a copy obtained when this sheet is copied is not easily reduced. Consequently, the effect of the copy-forgery-inhibited pattern image formed on the sheet is reduced. In other words, the image quality of the copy-forgery-inhibited pattern image cannot be guaranteed, and image quality deteriorates.

### <Vector Copy-Forgery-Inhibited Pattern Image in Detail>

As described above, bitmap image data compiles the color data and density data of a plurality of pixels, and also includes data in a compressed state (JPEG data, etc.).

On the other hand, vector image data exists in contrast to bitmap image data. Vector image data includes data expressed by an equation or the like used when creating bitmap image data. Converting vector image data to bitmap image data is called rastering or rasterizing. Consequently, bitmap image data is also called raster data.

Vector copy-forgery-inhibited pattern image data is constituted by boundary vector data and given command data. Boundary vector data shows the partition (boundary) between a latent image area and a background area. In the present embodiment, boundary vector data is outline character font data.

The given command data shows a command to “dispose bitmap latent image pattern data in the latent image area and bitmap background pattern data in the background area.” The bitmap latent image pattern data and the bitmap background pattern data are not, however, included in vector copy-forgery-inhibited pattern image data. As described above, bitmap latent image pattern data and bitmap background pattern data are included in bitmap copy-forgery-inhibited pattern image data.

When the printing apparatus receives vector copy-forgery-inhibited pattern image data transmitted from an information processing apparatus, the printing apparatus disposes bitmap latent image pattern data and bitmap background pattern data stored in a storage unit (e.g., memory) of the printing apparatus in a corresponding storage area in the storage unit. Bitmap copy-forgery-inhibited pattern image data is thus generated.

Hereinafter, print data is also referred to as PDL data. In the first embodiment of the present invention, print data generated when a user selects copy-forgery-inhibited pattern image printing includes bitmap document image data, bitmap copy-forgery-inhibited pattern image data and vector copy-forgery-inhibited pattern image data.

### <Overview of Printing System>

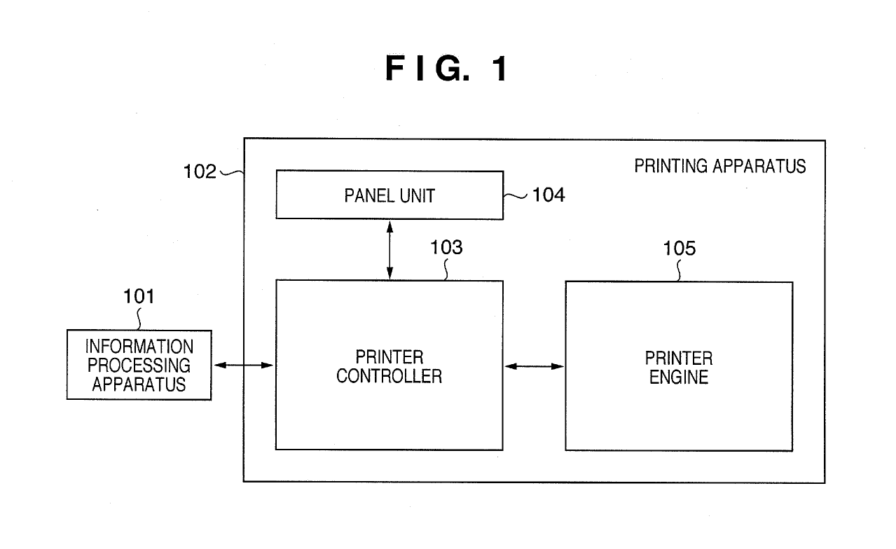

FIG. 1 shows the configuration of a printing system applicable in the embodiments of the present invention. The printing system shown in FIG. 1 includes an information processing apparatus 101 and a printing apparatus 102. The information processing apparatus 101 and the printing apparatus 102 are connected across a network. The network is the Internet, a LAN, a WAN, a telephone circuit, a dedicated digital circuit, an ATM, a frame relay circuit, a satellite communications circuit, a cable TV circuit, a wireless circuit for data broadcasting, or the like. The network may also be a communications network realized by a combination of these networks, provided that data reception and transmission are possible.

In FIG. 1, the information processing apparatus 101 is a computer, for example, and functions as a supply source of image information and a control apparatus for the printing apparatus 102. In the present embodiment, the printing apparatus 102 is a laser beam printer (LBP). The printing apparatus 102 is, however, not limited to the LBP, and may be a printer using another printing method such as inkjet or thermal transfer.

A printer controller 103 generates bitmap image data for each page, based on print data (e.g., PDL data) transmitted from the information processing apparatus 101, and transmits the generated bitmap image data to a printer engine 105.

The printer engine 105 forms a latent image on a photosensitive drum based on image data transmitted from the printer controller 103, and records an image by transferring/fixing the latent image to a recording medium (electrophotographic method). Note that in the specification of the present invention, this printer engine may be referred to as “printing unit”.

A panel unit 104 is used as a user interface. The user is able to instruct desired operations by operating the panel unit 104. The panel unit 104 is constituted by a touch panel that includes an operation unit and a display unit, for example. The processing content of the printing apparatus 102 and warning messages to the user are displayed on the display unit. The user is able to instruct and configure various processing via the operation unit.

The information processing apparatus 101 includes standard constituent elements equipped in a general-purpose computer (e.g., CPU, RAM, ROM, hard disk, external storage device, network interface, display, keyboard, mouse, etc.).

A printer driver for controlling the printing apparatus 102 and control programs including various application programs are stored in the ROM of the information processing apparatus 101. The CPU of the information processing apparatus 101 realizes various processing by reading and executing the control programs stored in the ROM.

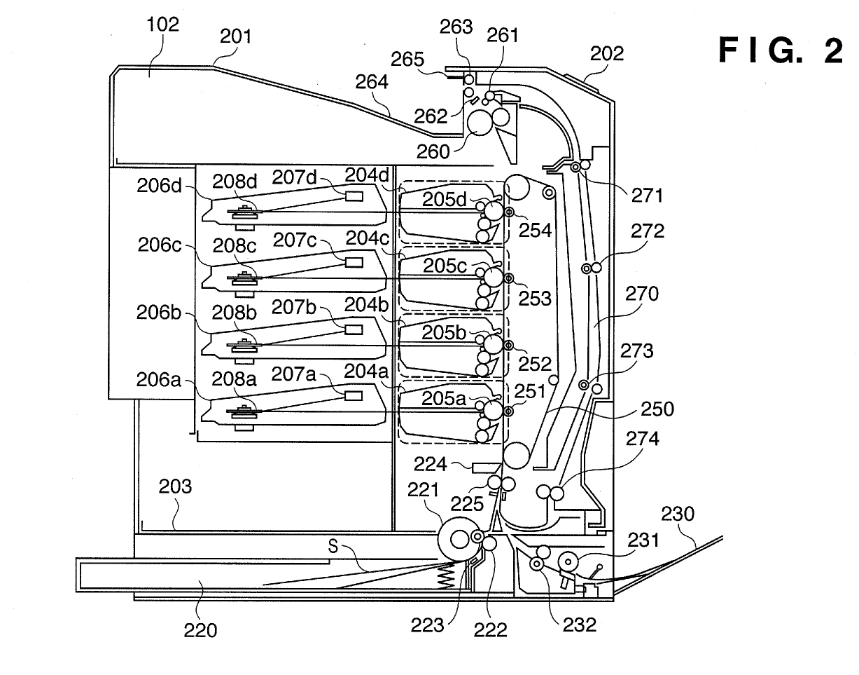

A description will be given of the configuration of a tandem color LBP as an exemplary printing apparatus 102. FIG. 2 is a cross-sectional view showing the configuration of the tandem color LBP, which is an exemplary printing apparatus according to the present invention.

The printing apparatus 102 include a housing 201. An LED display, LCD display or the like for displaying messages, printer settings, switches for the user to give various instructions, and the like is disposed in an operation panel 202. The operation panel 202 is one embodiment of the panel unit 104 shown in FIG. 1. A board housing unit 203 houses a board constituting the electronic circuitry of the printer controller 103 and the printer engine 105 shown in FIG. 1.

A paper cassette 220 holds paper (recording medium) S. The paper cassette 220 includes a mechanism for detecting paper size electrically using a divider (not shown). A cassette clutch 221 includes a cam for removing the top sheet of paper S held in the paper cassette 220, and transporting the removed sheet of paper S to a feed roller 222 using a driving force transmitted from a drive unit (not shown). The cam rotates intermittently whenever paper is fed, and feeds one sheet of paper S per rotation. A paper detection sensor 223 detects the amount of paper S held in the paper cassette 220.

The feed roller 222 transports the leading edge of paper S to a resist shutter 224. The resist shutter 224 stops the feeding by applying a pressing force to the paper S.

A manual feed clutch 231 is used for transporting the leading edge of paper S to a manual feed roller 232. The manual feed roller 232 transports the leading edge of paper S to the resist shutter 224. Paper S provided for image recording is fed from the paper cassette 220 or a manual feed tray 230.

The printer engine 105 communicates with the printer controller 103 based on a prescribed communication protocol, and selects the paper cassette 220 or the manual feed tray 230 as a feeding unit for feeding paper S in accordance with instructions from the printer controller 103. The printer engine 105 also transports paper S from the feeding unit to the resist shutter 224 in response to a print start instruction. Note that the printer engine 105 includes a feeding unit, a mechanism relating to an electrophotographic process for forming, transferring and fixing latent images, a discharging unit, and a control unit for these constituent elements.

Image recording units 204a, 204b, 204c and 204d include photosensitive drums 205a, 205b, 205c and 205d, respectively, and a toner holding unit, and form a toner image on paper S using an electrophotographic process. Laser scanner units 206a, 206b, 206c and 206d supply image information by laser beam to the image recording units 204a, 204b, 204c and 204d, respectively.

A paper transport belt 250 that transports paper S is stretched flatly in a paper transport direction (upwardly from the bottom of FIG. 2) between a plurality of rotation rollers 251 to 254 in the image recording units 204a, 204b, 204c and 204d. Paper S is electrostatically suctioned to the paper transport belt 250 by a suction roller 225 that applies bias at the most upstream portion of the paper transport belt 250. The four photosensitive drums 205a, 205b, 205c and 205d are linearly arranged facing the transport surface of the paper transport belt 250. Chargers and developers are arranged sequentially around a vicinity of the periphery of the corresponding photosensitive drums 205a, 205b, 205c and 205d in each of the image recording units 204a, 204b, 204c and 204d.

The laser scanner units 206a, 206b, 206c and 206d include laser units 207a, 207b, 207c and 207d, respectively. The laser units 207a, 207b, 207c and 207d emit laser beams by driving a semiconductor laser according to image signals (or video signals) transmitted from the printer controller 103. Laser beams emitted from the laser units 207a, 207b, 207c and 207d are scanned by polygon mirrors (rotating polygon mirrors) 208a, 208b, 208c and 208d, respectively, and form a latent image on the photosensitive drums 205a, 205b, 205c and 205d, respectively.

A fixer 260 heat fixes the toner image formed on paper S by the image recording units 204a, 204b, 204c and 204d to paper S. A transport roller 261 transports and discharges paper S. A discharge sensor 262 detects a discharge state of paper S. A discharge/double-sided printing transport path switching roller 263 transports paper S in a discharge direction, and discharges paper S into a discharge tray 264 if the discharge of paper S is instructed. If double-sided transportation of paper S is instructed, the rotation direction of the discharge/double-sided printing transport path switching roller 263 is reversed once the trailing edge of paper S has passed the discharge sensor 262, and paper S is transported to a double-sided printing transport path 270 as a result of the switchback. A discharge load detecting sensor 265 detects a load of paper S in the discharge tray 264.

Paper S, having been transported to the double-sided printing transport path 270 by the discharge/double-sided printing transport path switching roller 263, is transported to the resist shutter 224 by double-sided printing transport rollers 271 to 274 used in double-sided printing. The double-sided printing transport rollers 271 to 274 then wait for an instruction to transport paper S to the image recording units 204a, 204b, 204c and 204d.

The printing apparatus 102 may include an optional paper feeding cassette or optional units such as an envelope feeder or a finisher.

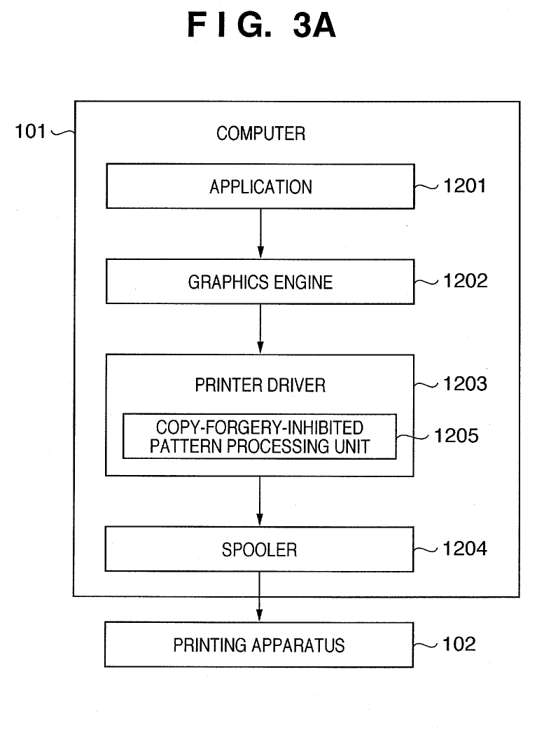

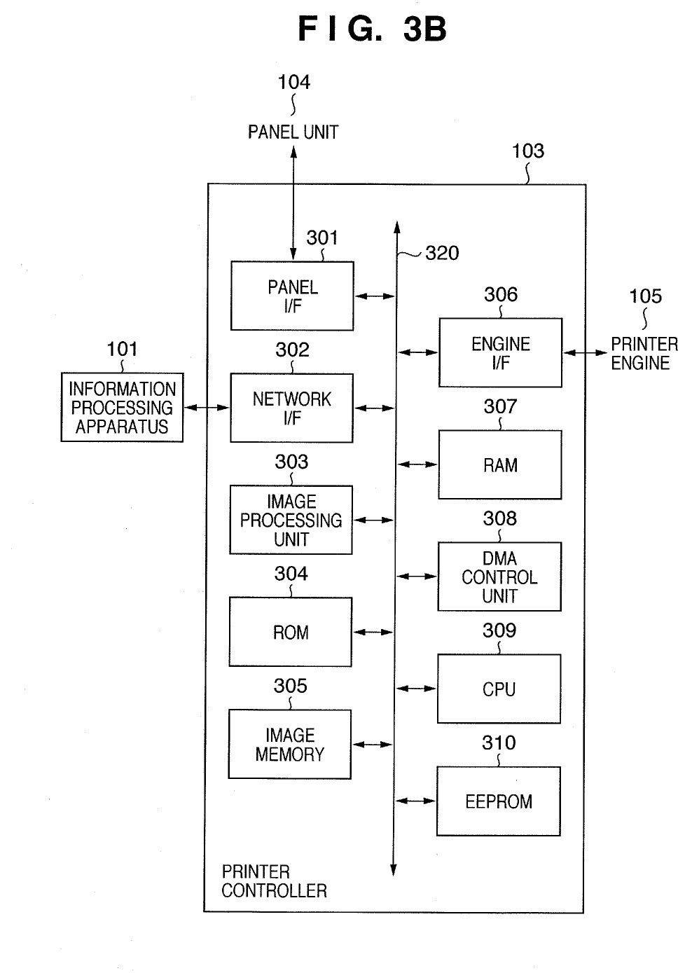

A description will be given of the information processing apparatus 101. FIG. 3A shows the functional configuration of the information processing apparatus 101 according to the present invention.

The user creates document image data using an application executable by the information processing apparatus 101. When “copy-forgery-inhibited pattern image printing” of document image data created by the user is instructed, the following process occurs.

A graphics engine 1202 converts document image data in GDI function format received from an application 1201 to document image data in DDI function format, and outputs the document image data in DDI function format to a printer driver 1203. Here, GDI stands for Graphics Device Interface, while DDI stands for Device Driver Interface.

The printer driver 1203 generates print data based on the document image data in DDI function format received from the graphics engine 1202 and copy-forgery-inhibited pattern image data generated by a copy-forgery-inhibited pattern processing unit 1205 in the printer driver 1203. The print data is, for example, PDL data written in a page description language. The PDL data is transmitted as print data to the printing apparatus 102 via a spooler 1204.

As described above, there are two types of the copy-forgery-inhibited pattern image data, namely, bitmap copy-forgery-inhibited pattern image data and vector copy-forgery-inhibited pattern image data. The printer driver 1203 generates at least one of bitmap copy-forgery-inhibited pattern image data and vector copy-forgery-inhibited pattern image data based on a “copy-forgery-inhibited pattern image printing” instruction from the user. In the first embodiment, however, the printer driver 1203 generates both bitmap copy-forgery-inhibited pattern image data and vector copy-forgery-inhibited pattern image data, based on the “copy-forgery-inhibited pattern image printing” instruction from the user. Then, as described above, the printer driver 1203 generates print data based on the generated copy-forgery-inhibited pattern image data and document image data.

Similarly to the copy-forgery-inhibited pattern image data, there are two types of document image data, namely, bitmap document image data and vector document image data. Hereinafter, an example will be described in which bitmap document image data in particular is used as document image data.

Next, a detail description will be given of the printer controller 103 of the printing apparatus. FIG. 3B is a block diagram showing the configuration of the printer controller 103 of the printing apparatus 102 according to the present invention.

In FIG. 3B, a panel interface (I/F) 301 performs data communication with the panel unit 104. A CPU 309 is able to check settings and instructions made in the panel unit 104 by the user, via the panel I/F 301. A network interface (I/F) 302 performs bi-directional communication with a data processing apparatus such as the information processing apparatus 101 across a network. An engine interface (I/F) 306 is communicably connected to the printer engine 105. The CPU 309 is able to recognize the status of the printer engine 105 via the engine I/F 306.

An image processing unit 303 generates bitmap image data for supplying to the printer engine 105, based on print data transmitted from the information processing apparatus 101. The image processing unit 303 generates bitmap image data by converting the resolution of the target print data to match the resolution of the printer engine 105 in the printing apparatus 102. A ROM 304 stores various control programs for controlling the printing apparatus 102, and bitmap/vector copy-forgery-inhibited pattern image data for use in substitute copy-forgery-inhibited pattern image printing, as well as various parameters and the like.

An image memory 305 temporarily stores generated image data. The CPU 309 controls the various constituent elements connected to a CPU bus 320, based on the control programs stored in the ROM 304.

A RAM 307 functions as a temporary storage memory for use by the CPU 309. The RAM 307 is constituted so that a memory capacity can be extended by optional RAM connected to an expansion port (not shown). The RAM 307 is also used as work memory temporarily utilized by the control programs stored in the ROM 304. An EEPROM 310 is a nonvolatile memory for storing various control information such as image processing performance and a density correction table for use in image processing by the image processing unit 303. A DMA control unit 308 transfers image data stored in the image memory 305 to the engine I/F 306 as the result of an instruction from the CPU 309.

The CPU bus 320 is constituted to include address, data and control buses. The CPU bus 320 connects the panel I/F 301, the network I/F 302, the image processing unit 303 and the ROM 304. The CPU bus 320 also connects the image memory 305, the engine I/F 306, the RAM 307, the DMA control unit 308, the CPU 309 and the EEPROM 310. All of the constituent elements connected to the CPU bus 320 can access and communicate with each other.

### <Description of Basic Flow of Printing System>

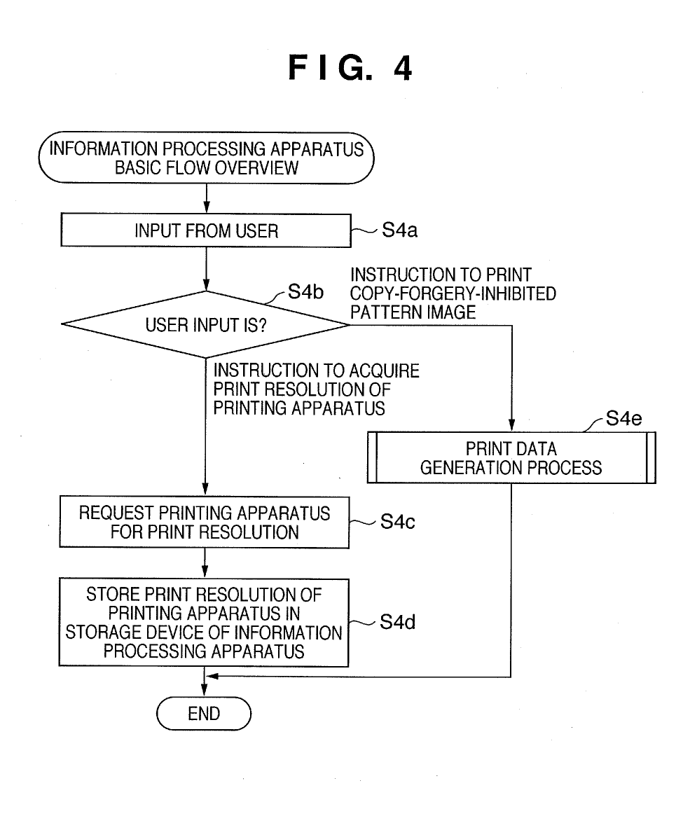

A description will be given of a basic process executed respectively by the information processing apparatus 101 and the printing apparatus 102 of the printing system. FIG. 4 is a flowchart showing the basic process executed by the information processing apparatus of the printing system according to the present invention. In FIG. 4, steps S4a to S4e show the steps of the basic process. The basic process shown in steps S4a to S4e is realized by programs stored in storage medium such as the RAM and ROM, under the control of the CPU of the information processing apparatus 101.

In step S4a, the information processing apparatus 101 receives an input from the user. In step S4b, the information processing apparatus 101 determines the content of the user input. If it is determined in step S4b that the user input is an instruction to acquire the print resolution of the printing apparatus (e.g., a printing apparatus A), process proceeds to step S4c. In step S4c, the information processing apparatus 101 requests the printing apparatus A for the print resolution. Next, in step S4d, the information processing apparatus 101 stores the print resolution of the printing apparatus A as default print resolution information in a storage device of the information processing apparatus such as a HDD, and ends the process.

On the other hand, if it is determined in step S4b that the user input is an instruction to print a copy-forgery-inhibited pattern image, process proceeds to step S4e. In step S4e, the information processing apparatus 101 executes a print data generation process, and ends the process. This print data generation process will be described in detail later for each of the exemplary embodiments described herein.

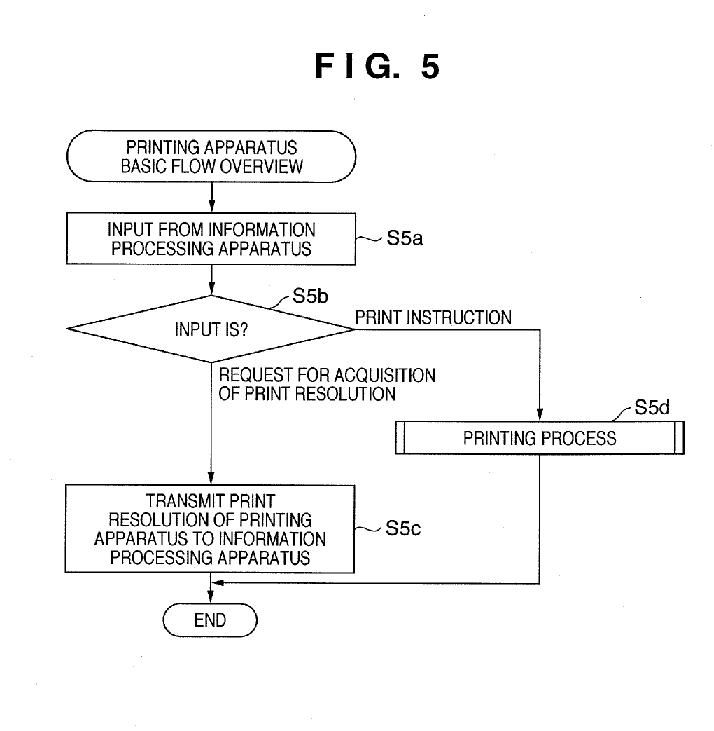

FIG. 5 is a flowchart showing the basic process executed by the printing apparatus of the printing system according to the present invention. In FIG. 5, steps S5a to S5d show the steps of the basic process. The basic process of steps S5a to S5d is realized by programs stored in storage media such as the RAM 307 and the ROM 304, under the control of the CPU 309 of the printing apparatus 102.

In step S5a, the printing apparatus 102 receives an input from the information processing apparatus 101. In step S5b, the printing apparatus 102 determines the content of the input from the information processing apparatus 101. If it is determined in step S5b that the input from the information processing apparatus 101 is a request for acquisition of the print resolution of the printing apparatus 102, process proceeds to step S5c. In step S5c, the printing apparatus 102 transmits the requested print resolution to the information processing apparatus 101, and ends the process.

On the other hand, if it is determined in step S5b that the input from the information processing apparatus 101 is a print instruction, process proceeds to step S5d. In step S5d, the printing apparatus 102 executes a printing process, and ends the process. This printing process will be described in detail later for each of the exemplary embodiments described herein.

The first exemplary embodiment is described in terms of a printing system shown in FIG. 1 printing on a sheet based on print data that includes bitmap document image data, vector copy-forgery-inhibited pattern image data and bitmap copy-forgery-inhibited pattern image data.

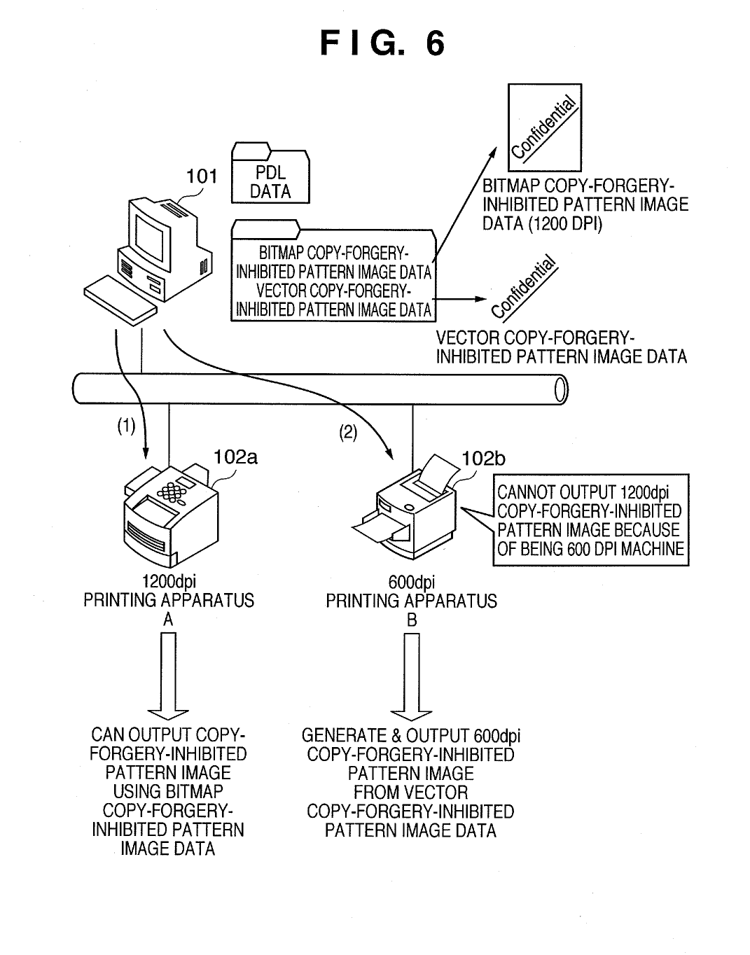

FIG. 6 illustrates an exemplary process of the printing system according to the first embodiment of the present invention. Referring to FIG. 6, the printing apparatus A (102a) and the printing apparatus B (102b) includes the basic configuration of the printing apparatus 102 shown in FIG. 1, and different print resolutions. The print resolution of the printing apparatus A is 1200 dpi, while the print resolution of the printing apparatus B is 600 dpi.

In FIG. 6, the information processing apparatus 101 generates print data that includes bitmap document image data and copy-forgery-inhibited pattern image data (both vector and bitmap copy-forgery-inhibited pattern image data). In this generation process, the information processing apparatus 101 is assumed to generate copy-forgery-inhibited pattern image data having the print resolution of the printing apparatus A, via a printer driver for the printing apparatus A. Also, in the first embodiment, the information processing apparatus 101 generates two types of copy-forgery-inhibited pattern image data (vector and bitmap copy-forgery-inhibited pattern image data) having the print resolution of the printing apparatus A (1200 dpi).

Vector copy-forgery-inhibited pattern image data generated by the information processing apparatus 101 is, as described later, transmitted to the printing apparatus 102, where it is converted to bitmap copy-forgery-inhibited pattern image data by the printing apparatus 102 and printed on a sheet.

(1) Consider a case where the information processing apparatus 101 transmits print data that includes 1200 dpi bitmap copy-forgery-inhibited pattern image data to the printing apparatus A (1200 dpi print resolution). In this case, the printing apparatus A does not need to convert the resolution of the bitmap copy-forgery-inhibited pattern image data included in the print data. Consequently, the printing apparatus A is able to print the bitmap copy-forgery-inhibited pattern image data onto a sheet as is, and guarantee the image quality of the copy-forgery-inhibited pattern image formed on the sheet. In this case, the printing apparatus A synthesizes the bitmap document image data and the bitmap copy-forgery-inhibited pattern image data included in the print data, and prints the resultant bitmap composite image data onto a sheet.

(2) Consider a case where the information processing apparatus 101 transmits print data that includes 1200 dpi bitmap copy-forgery-inhibited pattern image data to the printing apparatus B (600 dpi print resolution). In this case, the printing apparatus B determines that the resolution of the bitmap copy-forgery-inhibited pattern image data included in the print data (1200 dpi) needs to be converted (1200 dpi 600 dpi), since the print resolution of the printing apparatus B is 600 dpi. In other words, the image quality of the copy-forgery-inhibited pattern image on a sheet cannot be guaranteed, as described above, if the printing apparatus B prints the bitmap copy-forgery-inhibited pattern image data onto a sheet as is. In view of this, the printing apparatus B generates 600 dpi bitmap copy-forgery-inhibited pattern image data from the vector copy-forgery-inhibited pattern image data included in the print data. The printing apparatus B synthesizes the generated bitmap copy-forgery-inhibited pattern image data and the bitmap document image data included in the print data, and prints the resultant bitmap composite image data onto a sheet.

Note that in the configuration of the printing system shown in FIG. 6, bitmap document image data included in the print data is also normally generated at a resolution of 1200 dpi, similarly to the bitmap copy-forgery-inhibited pattern image data. Consequently, in generating bitmap composite image data, the printing apparatus B, more precisely, converts the resolution of the 1200 dpi bitmap document image data (1200 dpi→600 dpi), and synthesizes the converted bitmap document image data with the bitmap copy-forgery-inhibited pattern image data.

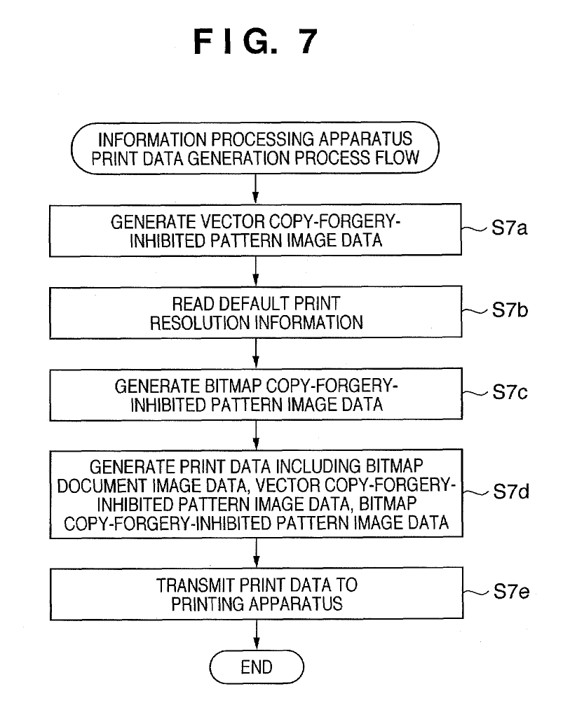

A description will be given of the print data generation process executed by the information processing apparatus 101 (step S4e in FIG. 4). FIG. 7 is a flowchart showing the print data generation process of the information processing apparatus according to the first embodiment of the present invention. In FIG. 7, steps S7a to S7e show the steps of the print data generation process. This print data generation process is realized by programs stored in storage media such as the RAM and ROM, under the control of the CPU of the information processing apparatus 101.

In step S7a, the information processing apparatus 101 generates vector copy-forgery-inhibited pattern image data. Next, in step S7b, the information processing apparatus 101 reads default print resolution information stored in its storage device. Note that, as described above, the default print resolution information shows a print resolution of 1200 dpi, for example.

In step S7c, the information processing apparatus 101 generates 1200 dpi bitmap copy-forgery-inhibited pattern image data, based on the default print resolution information. In step S7d, the information processing apparatus 101 generates print data that includes bitmap document image data generated separately, vector copy-forgery-inhibited pattern image data generated in step S7a, and bitmap copy-forgery-inhibited pattern image data generated in step S7c. In step S7e, the information processing apparatus 101 transmits the print data generated in step S7d to the printing apparatus 102, and ends the process.

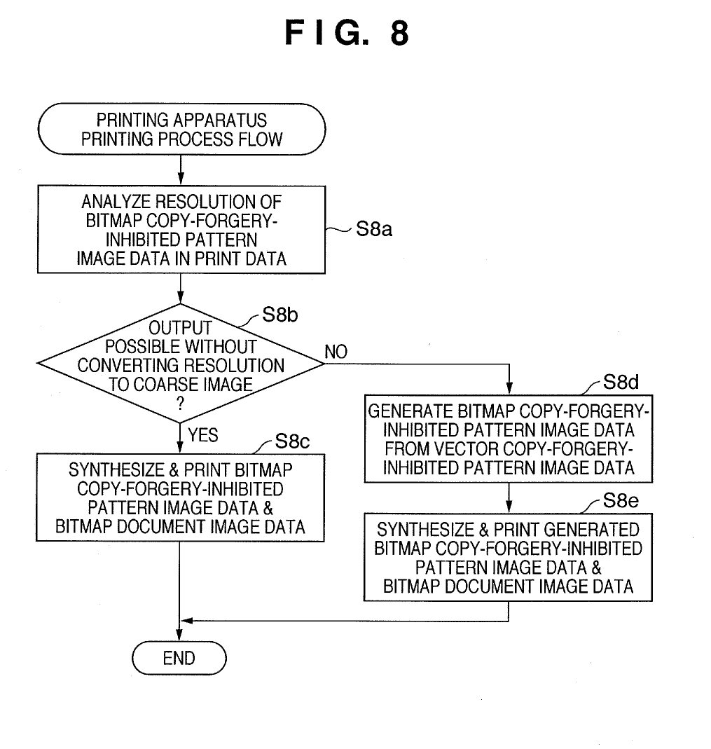

A description will be given of the printing process executed by the printing apparatus 102 (step S5d shown in FIG. 5). FIG. 8 is a flowchart showing the printing process of the printing apparatus according to the first embodiment of the present invention. In FIG. 8, steps S8a to S8e show the steps of the printing process. This printing process is realized by programs stored in storage media such as the RAM 307 and the ROM 304, under the control of the CPU 309 of the printing apparatus 102.

In step S8a, the printing apparatus 102 analyzes the resolution of the bitmap copy-forgery-inhibited pattern image data in the print data. In step S8b, the printing apparatus 102 determines whether output of the copy-forgery-inhibited pattern image is possible without converting the resolution of the bitmap copy-forgery-inhibited pattern image data to a coarse image.

The determination of step S8b is based on a result of comparing the resolution of the bitmap copy-forgery-inhibited pattern image data and the print resolution of the printing apparatus 102. If the resolution of the bitmap copy-forgery-inhibited pattern image data is greater than the print resolution of the printing apparatus 102, for example, it is determined that resolution conversion to the coarse image is necessary, since the image quality of the copy-forgery-inhibited pattern image to be printed on a sheet cannot be guaranteed, as described above. If the resolution of the bitmap copy-forgery-inhibited pattern image data is less than or equal to the print resolution of the printing apparatus 102, it is determined that output of the copy-forgery-inhibited pattern image is possible without converting the resolution to the coarse image, since image quality can be guaranteed even if the copy-forgery-inhibited pattern image is printed as is, as described above.

Note that the print resolution of the printing apparatus 102 refers to the print resolution of the printing unit (printer controller) of the printing apparatus 102.

If it is determined in step S8b that output of the copy-forgery-inhibited pattern image is possible without converting the resolution to the coarse image (step S8b: YES), process proceeds to step S8c. In step S8c, the printing apparatus 102 generates bitmap composite image data by synthesizing the bitmap document image data and the bitmap copy-forgery-inhibited pattern image data in the print data, and prints the bitmap composite image data onto a sheet.

On the other hand, if it is determined in step S8b that resolution conversion to the coarse image is necessary (step S8b: NO), process proceeds to step S8d. In step S8d, the printing apparatus 102 generates bitmap copy-forgery-inhibited pattern image data having the print resolution of the printing apparatus 102, based on the vector copy-forgery-inhibited pattern image data in the print data. Next, in step S8e, the printing apparatus 102 generates bitmap composite image data by synthesizing the bitmap document image data and the bitmap copy-forgery-inhibited pattern image data generated in step S8d, and prints the bitmap composite image data onto a sheet.

Note that in step S8b the printing apparatus 102 determines the resolution of the bitmap copy-forgery-inhibited pattern image data, although there is normally also the resolution of the bitmap document image data to consider.

Although image quality deteriorates greatly when bitmap copy-forgery-inhibited pattern image data is converted to a coarse image resolution, image quality does not deteriorates all that much when bitmap document image data is converted to a coarse image resolution. In view of this, in the embodiments of the present invention including the present embodiment, process is switched according to the resolution of bitmap copy-forgery-inhibited pattern image data with respect to which image quality deteriorates greatly (S8b, S11b, S15b), but not according to the resolution of bitmap document image data with respect to which image quality does not deteriorate all that much.

Thus, by only switching process according to the resolution of bitmap copy-forgery-inhibited pattern image data, process that involves a heavy process load (S8b, S11b, S15b) need not be executed frequently.

Thus, in the first embodiment, the printing apparatus adaptively selects, as copy-forgery-inhibited pattern image data in relation to which the image quality of the copy-forgery-inhibited pattern image can be guaranteed, the bitmap copy-forgery-inhibited pattern image data or the vector copy-forgery-inhibited pattern image data in the print data, based on the resolution of the copy-forgery-inhibited pattern image data and the print resolution of the printing apparatus. The printing apparatus is then able to print a copy-forgery-inhibited pattern image having the print resolution of the printing apparatus using the selected copy-forgery-inhibited pattern image data.

Even a printing apparatus that cannot print at the resolution of the print data is therefore able to print on a sheet with copy-forgery-inhibited pattern image data having the print resolution of the printing apparatus, and prevent the output of a copy-forgery-inhibited pattern image whose image quality cannot be guaranteed.

The first embodiment is described in terms of the information processing apparatus 101 transmitting print data that includes bitmap document image data, bitmap copy-forgery-inhibited pattern image data, and vector copy-forgery-inhibited pattern image data to the printing apparatus 102. If the processing capability of the information processing apparatus 101 is high, the total throughput of the overall system will not be affected even if the information processing apparatus 101 generates both the bitmap copy-forgery-inhibited pattern image data and the vector copy-forgery-inhibited pattern image data as copy-forgery-inhibited pattern image data. Also, where the printing apparatus 102 receives vector copy-forgery-inhibited pattern image data, it is possible to generate bitmap copy-forgery-inhibited pattern image data having the print resolution of the printing apparatus 102 based on the received vector copy-forgery-inhibited pattern image data if necessary.

In the first embodiment, however, only one of the bitmap copy-forgery-inhibited pattern image data and the vector copy-forgery-inhibited pattern image data received from the information processing apparatus 101 is used. The possibility thus arises of wasted storage resources or increased data traffic where the capacity of the storage device for storing data in the printing apparatus 102 is relatively unsecurable, or where the processing capability of the information processing apparatus 101 is not very high.

In view of this, the second embodiment is described in terms of the information processing apparatus 101 transmitting print data that includes bitmap document image data and bitmap copy-forgery-inhibited pattern image data to the printing apparatus 102, in order to make effective use of storage resources and avoid increased data traffic.

In the second embodiment, the information processing apparatus 101 regenerates bitmap copy-forgery-inhibited pattern image data having the print resolution of the printing apparatus 102, where the resolution of bitmap copy-forgery-inhibited pattern image data transmitted to the printing apparatus 102 is greater than the print resolution of the printing apparatus 102. The information processing apparatus 101 then retransmits the regenerated bitmap copy-forgery-inhibited pattern image data to the printing apparatus 102.

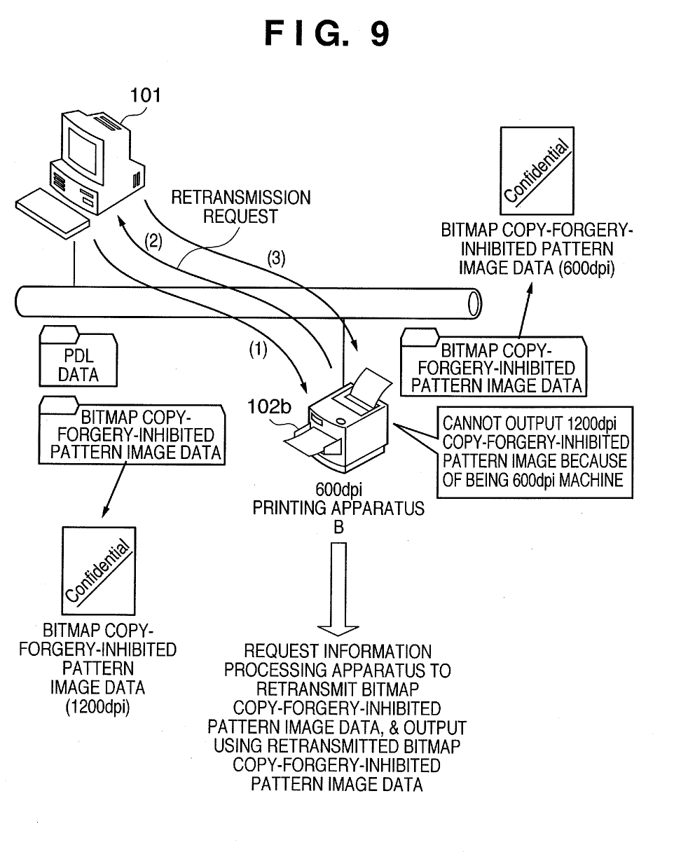

FIG. 9 illustrates an exemplary process of the printing system according to the second embodiment of the present invention. In FIG. 9, the information processing apparatus 101 generates print data that includes bitmap document image data and bitmap copy-forgery-inhibited pattern image data. In this generation process, the information processing apparatus 101 is assumed to generate copy-forgery-inhibited pattern image data having the print resolution of the printing apparatus A, via a printer driver for the printing apparatus A. Also, in the second embodiment, the information processing apparatus 101 generates bitmap copy-forgery-inhibited pattern image data having the print resolution of the printing apparatus A (1200 dpi).

(1) Consider a case where the information processing apparatus 101 transmits print data that includes 1200 dpi bitmap copy-forgery-inhibited pattern image data to the printing apparatus B (600 dpi print resolution). In this case, the printing apparatus B determines that the resolution of the bitmap copy-forgery-inhibited pattern image data included in the print data (1200 dpi) needs to be converted (1200 dpi 600 dpi), since the print resolution of the printing apparatus B is 600 dpi. In other words, the image quality of the copy-forgery-inhibited pattern image on a sheet cannot be guaranteed if the printing apparatus B prints the bitmap copy-forgery-inhibited pattern image data onto a sheet as is. In view of this, (2) the printing apparatus B terminates printing of the bitmap copy-forgery-inhibited pattern image data, and notifies the print resolution information of the printing apparatus B (600 dpi) and a request for retransmission of copy-forgery-inhibited pattern image data (hereinafter, retransmission request) to the information processing apparatus 101. Note that printing of the document image data is also terminated when printing of the bitmap copy-forgery-inhibited pattern image data is terminated. This is because document image data is to be printed after being synthesized with bitmap copy-forgery-inhibited pattern image data. Needless to say, printing may at this time be terminated after bitmap copy-forgery-inhibited pattern image data and document image data have actually been synthesized or without bitmap copy-forgery-inhibited pattern image data and document image data actually being synthesized. In either case, printing of composite image data to be obtained by synthesizing bitmap copy-forgery-inhibited pattern image data and document image data is terminated.

(3) The information processing apparatus 101 receives the retransmission request from the printing apparatus B, generates 600 dpi bitmap copy-forgery-inhibited pattern image data, and retransmits the generated image data to the printing apparatus B. The printing apparatus B synthesizes the retransmitted bitmap copy-forgery-inhibited pattern image data and the bitmap document image data in the print data, and prints the resultant bitmap composite image data onto a sheet.

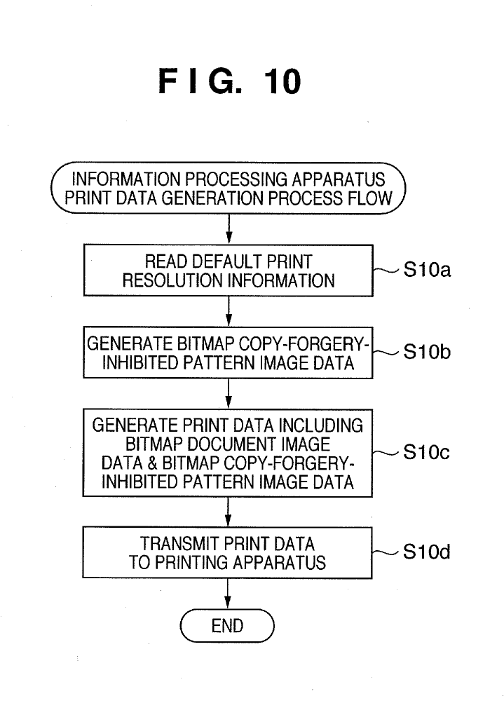

A description will be given of the print data generation process executed by the information processing apparatus 101 (step S4e in FIG. 4). FIG. 10 is a flowchart showing the print data generation process of the information processing apparatus according to the second embodiment of the present invention. In FIG. 10, steps S10a to S10d show the steps of the print data generation process. This print data generation process is realized by programs stored in storage media such as the RAM and ROM, under the control of the CPU of the information processing apparatus 101.

In step S10a, the information processing apparatus 101 reads default print resolution information stored in the storage device of the information processing apparatus 101. In step S10b, the information processing apparatus 101 generates 1200 dpi bitmap copy-forgery-inhibited pattern image data, based on the default print resolution information. In step S10c, the information processing apparatus 101 generates print data that includes bitmap document image data generated separately and the bitmap copy-forgery-inhibited pattern image data generated in step S10b. In step S10d, the information processing apparatus 101 transmits the print data generated in step S10c to the printing apparatus 102, and ends the process.

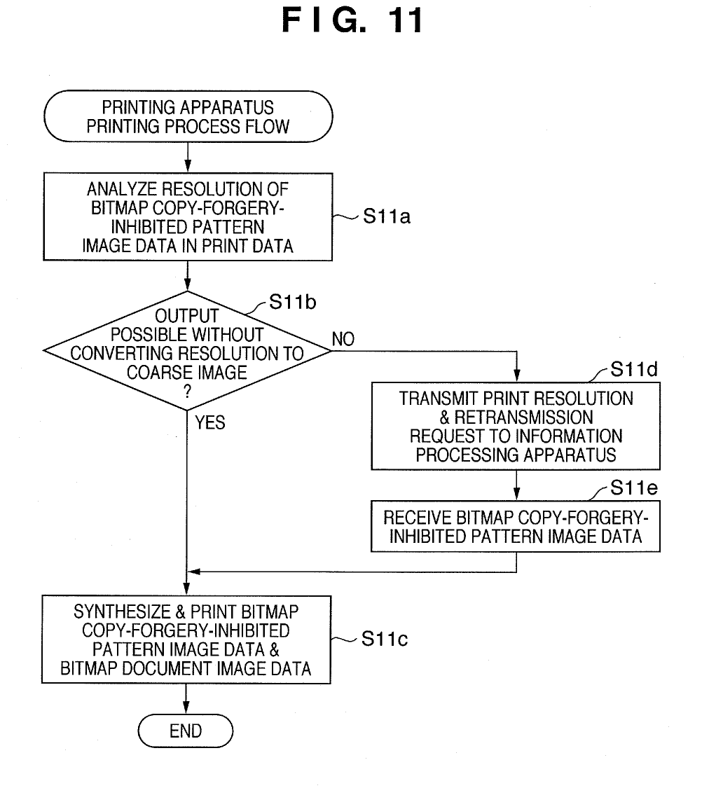

A description will be given of the printing process executed by the printing apparatus 102 (step S5d shown in FIG. 5). FIG. 11 is a flowchart showing the printing process of the printing apparatus according to the second embodiment of the present invention. In FIG. 11, steps S11a to S11e show the steps of the printing process. This printing process is realized by programs stored in storage media such as the RAM 307 and the ROM 304, under the control of the CPU 309 of the printing apparatus 102.

In step S11a, the printing apparatus 102 analyzes the resolution of the bitmap copy-forgery-inhibited pattern image data in the print data. In step S11b, the printing apparatus 102 determines whether output of the copy-forgery-inhibited pattern image is possible without converting the resolution of the bitmap copy-forgery-inhibited pattern image data to a coarse image. Since the determination method of step S11b is similar to step S8b in the first embodiment (see FIG. 8), detailed description is not repeated here.

If it is determined in step S11b that output of the copy-forgery-inhibited pattern image is possible without converting the resolution to the coarse image (step S11b: YES), process proceeds to step S11c. In step S11c, the printing apparatus 102 generates bitmap composite image data by synthesizing the bitmap copy-forgery-inhibited pattern image data and the bitmap document image data in the print data, and prints the bitmap composite image data onto a sheet.

On the other hand, if it is determined in step S11b that resolution conversion to the coarse image is necessary (step S11b: NO), process proceeds to step S11d. In step S11d, the printing apparatus 102 terminates the printing of bitmap copy-forgery-inhibited pattern image data onto a sheet, and transmits the print resolution information of the printing apparatus 102 and a request for retransmission of bitmap copy-forgery-inhibited pattern image data to the information processing apparatus 101. The retransmission request includes an identifier (ID) of the received print data. The information processing apparatus 101 is therefore able to identify which of the pieces of bitmap copy-forgery-inhibited pattern image data included in transmitted print data the retransmission request relates to.

In step S11e, the printing apparatus 102 receives bitmap copy-forgery-inhibited pattern image data from the information processing apparatus 101 in response to the retransmission request. In step S11c, the printing apparatus 102 generates bitmap composite image data by synthesizing the received bitmap copy-forgery-inhibited pattern image data and bitmap document image data, and prints the bitmap composite image data onto a sheet.

The bitmap copy-forgery-inhibited pattern image data received in step S11e may be included in print data, or received by itself. Note that where bitmap copy-forgery-inhibited pattern image data is received by itself, the bitmap document image data in the print data received prior to the retransmission request is temporarily stored in the RAM 307 of the printing apparatus 102. Then when bitmap copy-forgery-inhibited pattern image data is received in response to a retransmission request, the printing apparatus 102 generates bitmap composite image data by synthesizing the received bitmap copy-forgery-inhibited pattern image data and the stored bitmap document image data, and prints the bitmap composite image data onto a sheet.

Thus, in the process shown in FIG. 11, the printing apparatus 102 analyzes the resolution of the bitmap copy-forgery-inhibited pattern image data included in the print data. Further, the printing apparatus 102 determines whether to print the bitmap copy-forgery-inhibited pattern image data included in the print data onto a sheet, based on the analysis result.

In particular, the printing apparatus 102 interrupts the printing on a sheet of the bitmap copy-forgery-inhibited pattern image data included in the received print data if the resolution of the bitmap copy-forgery-inhibited pattern image data is greater than the print resolution of the printing apparatus 102. Here, “interrupt” refers to interrupting the operation by the printer engine 105 to print bitmap copy-forgery-inhibited pattern image data onto a sheet. The printing apparatus 102 requests the information processing apparatus 101 to retransmit bitmap copy-forgery-inhibited pattern image data having the print resolution of the printing apparatus 102, and prints the bitmap copy-forgery-inhibited pattern image data included in the print data transmitted again from the information processing apparatus 101. On the other hand, where the resolution of the bitmap copy-forgery-inhibited pattern image data is less than or equal to the print resolution of the printing apparatus 102, the printing apparatus 102 prints the bitmap copy-forgery-inhibited pattern image data included in the print data received from the information processing apparatus 101 onto a sheet.

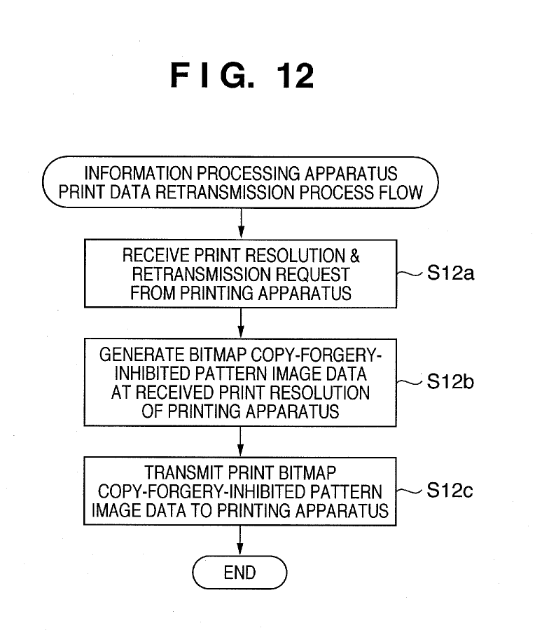

A description will be given of the print data retransmission process executed by the information processing apparatus 101 where a retransmission request is received from the printing apparatus 102. FIG. 12 is a flowchart showing the print data retransmission process of the information processing apparatus according to the second embodiment of the present invention. In FIG. 12, steps S12a to S12c show the steps of the print data retransmission process. This print data retransmission process is realized by programs stored in storage media such as the RAM and ROM, under the control of the CPU of the information processing apparatus 101. Also, the information processing apparatus 101 constantly or periodically monitors the status of the printing apparatus 102, and executes the print data retransmission process if a retransmission request is received as status information from the printing apparatus 102.

In step S12a, the information processing apparatus 101 receives a retransmission request and print resolution information of the printing apparatus 102 from the printing apparatus 102. In step S12b, the information processing apparatus 101, having received a retransmission request from the printing apparatus 102, generates bitmap copy-forgery-inhibited pattern image data having the resolution shown in the received print resolution information. Specifically, the information processing apparatus 101 identifies which of the pieces of bitmap copy-forgery-inhibited pattern image data included in transmitted print data the retransmission request relates to, based on the print data ID included in the retransmission request. Then, in relation to the identified bitmap copy-forgery-inhibited pattern image data, the information processing apparatus 101 generates bitmap copy-forgery-inhibited pattern image data having the print resolution of the printing apparatus 102.

In step S12c, the information processing apparatus 101 transmits the bitmap copy-forgery-inhibited pattern image data generated in step S12b to the printing apparatus 102, and ends the process. The bitmap copy-forgery-inhibited pattern image data may be transmitted as part of print data, or transmitted by itself.

Thus, in the second embodiment, the printing apparatus requests retransmission of bitmap copy-forgery-inhibited pattern image data having the print resolution of the printing apparatus, if it is determined that the image quality of the copy-forgery-inhibited pattern image to be printed on a sheet with received bitmap copy-forgery-inhibited pattern image data cannot be guaranteed. The printing apparatus is able to print a bitmap copy-forgery-inhibited pattern image having the print resolution of the printing apparatus using bitmap copy-forgery-inhibited pattern image data transmitted as a result of the retransmission request.

Note that in the present embodiment, printing of bitmap copy-forgery-inhibited pattern image data is terminated in step S11d. However, printing may be interrupted at this step rather than being terminated. A warning may then notify the user after interrupting the printing, and printing may be executed if the user instructs that printing be continued despite the warning.

Note also that in the present specification, the expression “terminate XXX process” indicates that XXX process is not executed. The expression “interrupt XXX process” indicates that execution of XXX process is stopped in the meantime. A process that has been stopped in the meantime may or may not be subsequently executed.

The first and second embodiments have been described in terms of bitmap copy-forgery-inhibited pattern image data having the print resolution of the printing apparatus being generated for printing by the printing apparatus itself, or received for printing from the information processing apparatus.

On the other hand, a third embodiment is described in terms of copy-forgery-inhibited pattern image data incorporated in the printing apparatus 102 being printed on a sheet, if the resolution of the bitmap copy-forgery-inhibited pattern image data is greater than the print resolution of the printing apparatus 102. In this case, copy-forgery-inhibited pattern image data incorporated in the printing apparatus 102 is used as substitute copy-forgery-inhibited pattern image data for the copy-forgery-inhibited pattern image data transmitted from the information processing apparatus 101.

The copy-forgery-inhibited pattern image data incorporated in the printing apparatus 102 is, for example, stored in the ROM 304, and constituted by vector copy-forgery-inhibited pattern image data or bitmap copy-forgery-inhibited pattern image data having the print resolution of the printing apparatus 102. In the third embodiment, bitmap copy-forgery-inhibited pattern image data is assumed to be stored in the ROM 304 as copy-forgery-inhibited pattern image data, in order to simplify the description.

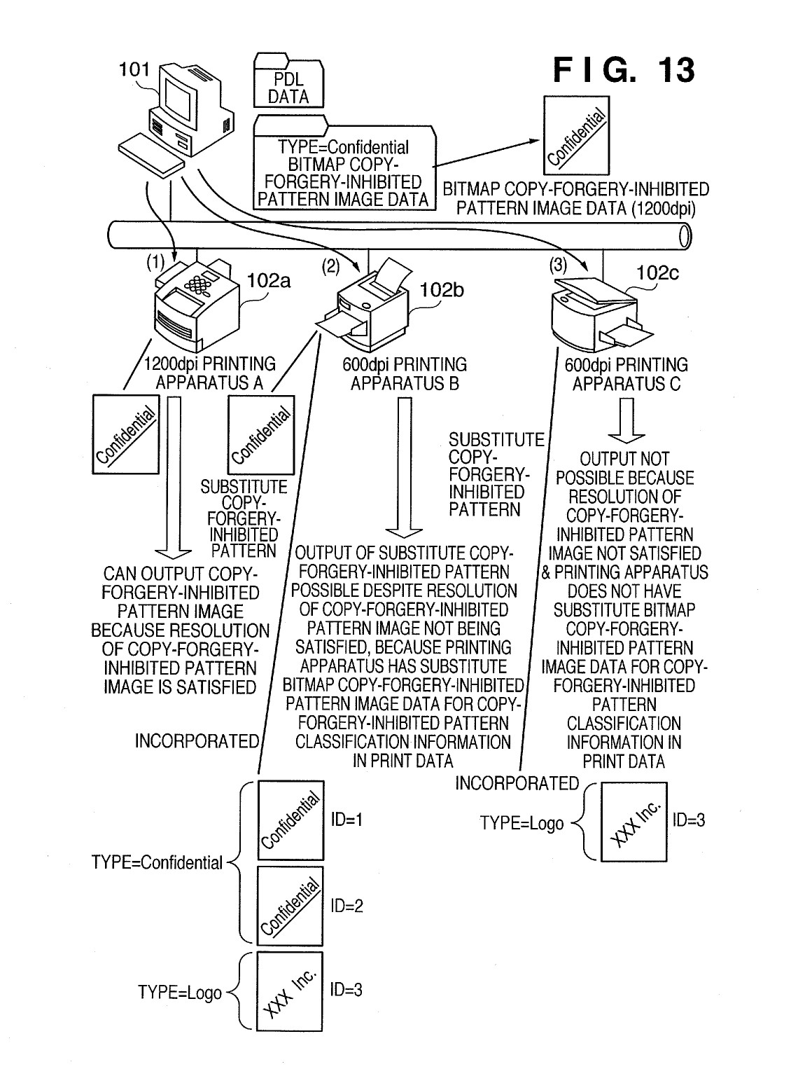

FIG. 13 illustrates a process of the printing system according to the third embodiment of the present invention. In FIG. 13, a printing apparatus C (102c) includes the basic configuration of the printing apparatus 102 shown in FIG. 1, and a print resolution of the printing apparatus C is 600 dpi.

In FIG. 13, the information processing apparatus 101 generates print data that includes bitmap document image data, copy-forgery-inhibited pattern classification information, and bitmap copy-forgery-inhibited pattern image data. In this generation process, the information processing apparatus 101 is assumed to generate bitmap copy-forgery-inhibited pattern image data having the print resolution of the printing apparatus A, via a printer driver for the printing apparatus A. Also, in the third embodiment, the information processing apparatus 101 generates bitmap copy-forgery-inhibited pattern image data having the print resolution of the printing apparatus A (1200 dpi). Here, the copy-forgery-inhibited pattern classification information included in the print data shows the type of bitmap copy-forgery-inhibited pattern image data, examples of which include “Confidential” and “Logo”. In the present embodiment, the copy-forgery-inhibited pattern classification information in the print data is “Confidential”.

The printing apparatuses A to C are restricted in terms of printing copy-forgery-inhibited pattern image data onto a sheet according to respective copy-forgery-inhibited pattern classification information. The printing apparatus A is not restricted; that is, printing on a sheet is permitted with the bitmap copy-forgery-inhibited pattern image data for any copy-forgery-inhibited pattern classification information. The printing apparatus A does not, however, incorporate substitute copy-forgery-inhibited pattern image data. The printing apparatus B incorporates substitute copy-forgery-inhibited pattern image data, and is permitted to print substitute copy-forgery-inhibited pattern image data for “Confidential” or “Logo” copy-forgery-inhibited pattern classification information onto a sheet. The printing apparatus C incorporates substitute copy-forgery-inhibited pattern image data, and is permitted to print substitute copy-forgery-inhibited pattern image data for “Logo” copy-forgery-inhibited pattern classification information onto a sheet.

(1) Consider a case where the information processing apparatus 101 transmits print data that includes 1200 dpi bitmap copy-forgery-inhibited pattern image data to the printing apparatus A (1200 dpi print resolution). In this case, the printing apparatus A does not need to convert the resolution of the bitmap copy-forgery-inhibited pattern image data included in the print data. Consequently, the printing apparatus A is able to print the bitmap copy-forgery-inhibited pattern image data onto a sheet as is, and guarantee the image quality of the copy-forgery-inhibited pattern image formed on the sheet. In this case, the printing apparatus A synthesizes the bitmap document image data and the bitmap copy-forgery-inhibited pattern image data included in the print data, and prints the resultant bitmap composite image data onto a sheet.

(2) Consider a case where the information processing apparatus 101 transmits print data that includes 1200 dpi bitmap copy-forgery-inhibited pattern image data to the printing apparatus B (600 dpi print resolution). In this case, the printing apparatus B determines that the resolution of the bitmap copy-forgery-inhibited pattern image data included in the print data (1200 dpi) needs to be converted (1200 dpi 600 dpi), since the print resolution of the printing apparatus B is 600 dpi. In other words, the image quality of the copy-forgery-inhibited pattern image on a sheet cannot be guaranteed if the printing apparatus B prints the bitmap copy-forgery-inhibited pattern image data onto a sheet as is. The printing apparatus B, however, incorporates pieces of bitmap copy-forgery-inhibited pattern image data corresponding to the “Confidential” copy-forgery-inhibited pattern classification information included in the print data. In view of this, the printing apparatus B is able to print bitmap copy-forgery-inhibited pattern image data onto a sheet as is by selecting one of these pieces of bitmap copy-forgery-inhibited pattern image data and employing the selected data as substitute bitmap copy-forgery-inhibited pattern image data. In this case, the printing apparatus B synthesizes the bitmap document image data included in the print data and substitutes copy-forgery-inhibited pattern image data incorporated in the printing apparatus, and prints the resultant bitmap composite image data onto a sheet.

(3) Consider a case where the information processing apparatus 101 transmits print data that includes 1200 dpi bitmap copy-forgery-inhibited pattern image data to the printing apparatus C (600 dpi print resolution). In this case, the printing apparatus C determines that the resolution of the bitmap copy-forgery-inhibited pattern image data included in the print data (1200 dpi) needs to be converted (1200 dpi 600 dpi), since the print resolution of the printing apparatus C is 600 dpi. In other words, the image quality of the copy-forgery-inhibited pattern image on a sheet cannot be guaranteed if the printing apparatus C prints the bitmap copy-forgery-inhibited pattern image data onto a sheet as is. The printing apparatus C terminates the printing of copy-forgery-inhibited pattern image data onto a sheet, since bitmap copy-forgery-inhibited pattern image data corresponding to the “Confidential” copy-forgery-inhibited pattern classification information included in the print data is not incorporated. Note that terminating the printing of copy-forgery-inhibited pattern image data onto a sheet includes a case where printing of bitmap composite image data generated by synthesizing bitmap copy-forgery-inhibited pattern image data and bitmap document image data onto a sheet is terminated. Terminating the printing of copy-forgery-inhibited pattern image data onto a sheet also includes a case where only the printing of bitmap copy-forgery-inhibited pattern image data onto a sheet is terminated. Consequently, the printing of bitmap document image data onto a sheet is executed, where only the printing of bitmap copy-forgery-inhibited pattern image data onto a sheet is terminated.

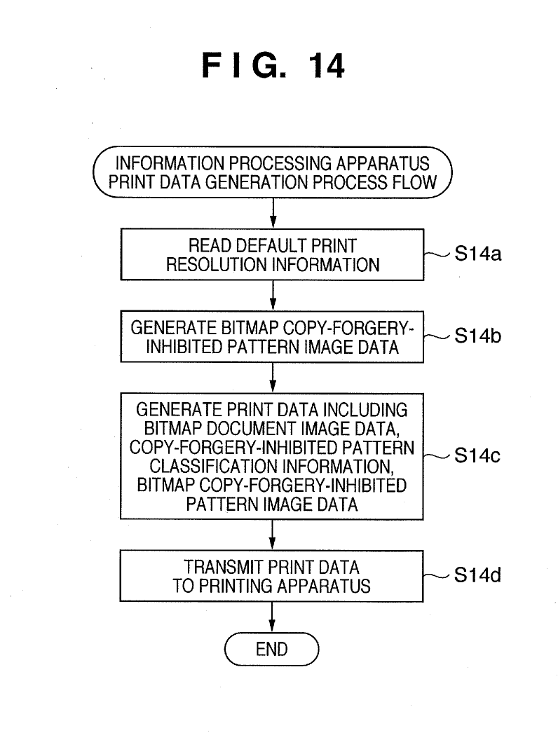

A description will be given of the print data generation process executed by the information processing apparatus 101 (step S4e in FIG. 4). FIG. 14 is a flowchart showing a print data generation process of the information processing apparatus according to the third embodiment of the present invention. In FIG. 14, steps S14a to S14d show the steps of the print data generation process. This print data generation process is realized by programs stored in storage media such as the RAM and ROM, under the control of the CPU of the information processing apparatus 101.

In step S14a, the information processing apparatus 101 reads default print resolution information stored in the storage device of the information processing apparatus 101. In step S14b, the information processing apparatus 101 generates 1200 dpi bitmap copy-forgery-inhibited pattern image data based on the default print resolution information. In step S14c, the information processing apparatus 101 generates print data that includes bitmap document image data generated separately, the bitmap copy-forgery-inhibited pattern image data generated in step S14b, and copy-forgery-inhibited pattern classification information thereof. In step S14d, the information processing apparatus 101 transmits the print data generated in step S14c to the printing apparatus 102, and ends the process.

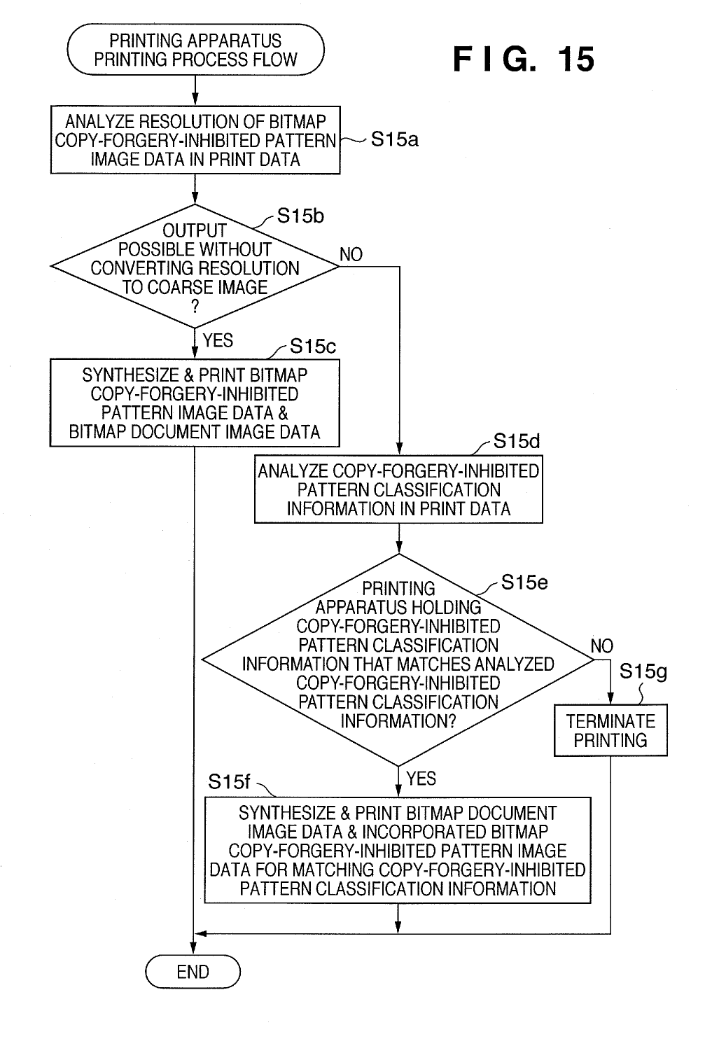

A description will be given of the printing process executed by the printing apparatus 102 (step S5d shown in FIG. 5). FIG. 15 is a flowchart showing a printing process of the printing apparatus according to the third embodiment of the present invention. In FIG. 15, steps S15a to S15g show the steps of the printing process. This printing process is realized by programs stored in storage media such as the RAM 307 and the ROM 304, under the control of the CPU 309 of the printing apparatus 102.

In step S15a, the printing apparatus 102 analyzes the resolution of the bitmap copy-forgery-inhibited pattern image data in the print data. In step S15b, the printing apparatus 102 determines whether output of the copy-forgery-inhibited pattern image is possible without converting the resolution of the bitmap copy-forgery-inhibited pattern image data to a coarse image. Since the determination method of step S15b is similar to step S8b in the first embodiment (see FIG. 8), detailed description is not repeated here.

If it is determined in step S15b that output of the copy-forgery-inhibited pattern image is possible without converting the resolution to the coarse image (step S15b: YES), process proceeds to step S15c. In step S15c, the printing apparatus 102 generates bitmap composite image data by synthesizing the bitmap copy-forgery-inhibited pattern image data and the bitmap document image data in the print data, and prints the bitmap composite image data onto a sheet.

On the other hand, if it is determined in step S15b that resolution conversion to the coarse image is necessary (step S15b: NO), process proceeds to step S15d. In step S15d, the printing apparatus 102 interrupts the printing of bitmap copy-forgery-inhibited pattern image data onto a sheet, and analyzes the copy-forgery-inhibited pattern classification information in the print data. In step S15e, the printing apparatus 102 determines whether copy-forgery-inhibited pattern classification information matching the copy-forgery-inhibited pattern classification information analyzed in step S15d is being held (stored) in the printing apparatus 102.

If it is determined in step S15e that matching copy-forgery-inhibited pattern classification information is being held (step S15e: YES), process proceeds to step S15f. In step S15f, the printing apparatus 102 generates bitmap composite image data by synthesizing bitmap document image data and incorporated bitmap copy-forgery-inhibited pattern image data for the matching copy-forgery-inhibited pattern classification information, and prints the bitmap composite image data onto a sheet.

On the other hand, if it is determined in step S15e that matching copy-forgery-inhibited pattern classification information is not being held (stored) (step S15e: NO), process proceeds to step S15g. In step S15g, the printing apparatus 102 terminates the printing process, and ends the process.

Thus, in the third embodiment, bitmap copy-forgery-inhibited pattern image data incorporated in the printing apparatus 102 is printed on a sheet where it is determined that the image quality of the copy-forgery-inhibited pattern image to be printed on a sheet with the received bitmap copy-forgery-inhibited pattern image data cannot be guaranteed.

In particular, the printing apparatus 102 prints bitmap copy-forgery-inhibited pattern image data incorporated in the printing apparatus 102 onto a sheet, according to copy-forgery-inhibited pattern classification information and the resolution of received copy-forgery-inhibited pattern image data. The printing apparatus 102 is thus both able to reliably print a copy-forgery-inhibited pattern image at the print resolution of the printing apparatus 102, and to terminate printing where an appropriate copy-forgery-inhibited pattern image cannot be printed.

Note that although the print target of the printing apparatus 102 in the first to third embodiments is a copy-forgery-inhibited pattern image, the present invention is not limited to this. Any print target is possible, provided, for example, the user wants to print the print target in the printing apparatus 102 with the intended image quality guaranteed. The present invention is also applicable where identification information (e.g., barcodes or two dimensional barcodes) for printing together with the document image or additional information such as headers or footers is printed in order to identify the content of the printed material.

The first to third embodiments are described in terms of bitmap document image data being used as document image data, although it is also possible to use vector document image data, as aforementioned. In this case, the printing apparatus 102 generates bitmap composite image data having the print resolution of the printing apparatus 102 from the vector document image data, and synthesizes the bitmap copy-forgery-inhibited pattern image data.

Although exemplary embodiments of the present invention have been described above, the present invention can take an embodiment as a system, apparatus, method, program, or storage medium, for example. Specifically, the present invention may be applied to a system constituted by a plurality of devices, or an apparatus composed of a single device.

In the above embodiments, process is switched depending on whether or not the print resolution is greater than or equal to the resolution of bitmap copy-forgery-inhibited pattern image data (S8b, S11b, S15b).

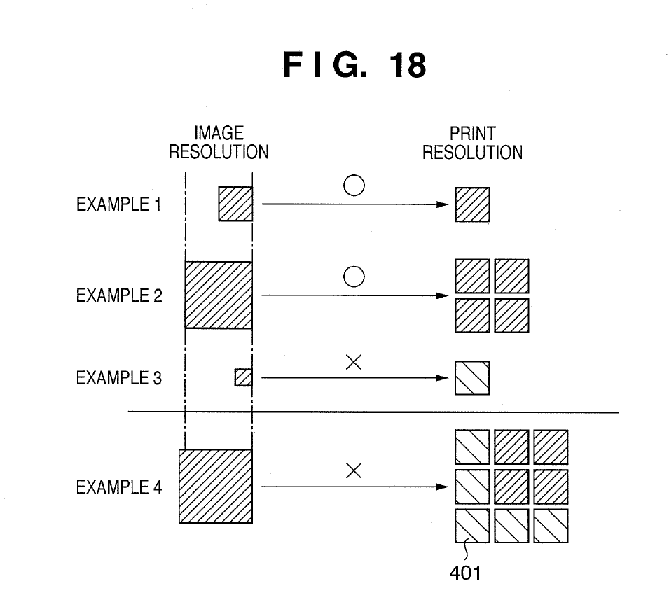

However, a more desirable result may be obtained when process is switched depending on whether or not the print resolution is a positive integer multiple of the resolution of bitmap copy-forgery-inhibited pattern image data. This is described with reference to FIG. 18.

In FIG. 18, example 1 shows a case where the resolution of the bitmap copy-forgery-inhibited pattern image data and the print resolution are both 600 dpi. In this case, the resolution of the bitmap copy-forgery-inhibited pattern image data does not need to be converted. Consequently, printing of the bitmap copy-forgery-inhibited pattern image data can be continued.

Example 2 shows a case where the resolution of the bitmap copy-forgery-inhibited pattern image data is 300 dpi, while the print resolution is 600 dpi. In this case, the resolution of the bitmap copy-forgery-inhibited pattern image data needs to be converted. However, each pixel of the 300 dpi bitmap copy-forgery-inhibited pattern image data can simply be divided into 2×2 pixels. Consequently, printing of the bitmap copy-forgery-inhibited pattern image data can be continued.

Example 3 shows a case where the resolution of the bitmap copy-forgery-inhibited pattern image data is 1200 dpi, while the print resolution is 600 dpi. In this case, the resolution of the bitmap copy-forgery-inhibited pattern image data needs to be converted. Moreover, the resolution conversion is not simple but complicated, involving using each pixel of the 1200 dpi bitmap copy-forgery-inhibited pattern image data and three neighboring pixels to create image data that matches the 600 dpi print resolution. This complicated resolution conversion results in pixels that were black in the bitmap copy-forgery-inhibited pattern image data becoming gray. Consequently, printing of the bitmap copy-forgery-inhibited pattern image data can be is interrupted or terminated. Note that in this case the processing performed subsequent to the printing of the bitmap copy-forgery-inhibited pattern image data being interrupted or terminated is the same as that performed in the above embodiments.

Example 4 shows a case where the resolution of the bitmap copy-forgery-inhibited pattern image data is 250 dpi, while the print resolution is 600 dpi. In this case, the resolution of the bitmap copy-forgery-inhibited pattern image data needs to be converted. Moreover, the resolution conversion is not simple but complicated, involving creating nine pixels of image data from each pixel of the 250 dpi bitmap copy-forgery-inhibited pattern image data. This complicated resolution conversion results in pixels that were black in the bitmap copy-forgery-inhibited pattern image data becoming gray (e.g. pixel 401).

Consequently, in example 4, printing of the bitmap copy-forgery-inhibited pattern image data can be interrupted or terminated, despite the print resolution being greater than or equal to the resolution of the bitmap copy-forgery-inhibited pattern image data. Note that in this case the processing performed subsequent to the printing of the bitmap copy-forgery-inhibited pattern image data being interrupted or terminated is the same as that performed in the above embodiments.

The above-described embodiment is described with reference to a copy-forgery-inhibited image. However, this invention isn't limited to a copy-forgery-inhibited image, but could apply to other kinds of images, such as a bar code, a two dimension code, etc.

The present invention can be achieved by directly or remotely supplying a software program that realizes the functions of the above embodiments (in the embodiments, a program corresponding to the flowcharts shown in the drawings) to a system or apparatus, and by reading and executing the supplied program code with a computer in the system or apparatus.

Consequently, the present invention is also realized by the actual program code installed on a computer in order to realize the functional processing of the present invention by computer.

In this case, the program can take any form, such as object code, a program executed by an interpreter, or script data supplied to an OS, for example, provided it has the functions of a program.

Examples of recording media for supplying the program include floppy disk, hard disk, and optical disk. Further, recording media include magneto-optical disk (MO), CD-ROM, CD-R, CD-RW, magnetic tape, nonvolatile memory card, ROM, and DVD (DVD-ROM, DVD-R).

The program may also be supplied by accessing a website on the Internet using the browser of a client computer, and downloading the actual computer program of the present invention from the website, or downloading a compressed file that includes an automatic installation function onto a recording medium such as a hard disk. It is also possible to divide the program code constituting the program of the present invention into a plurality of files, and download the individual files from different websites. That is, the present invention also includes a WWW server that allows a plurality of users to download program files for realizing the functional processing of the present invention on a computer.

The program of the present invention may also be distributed to users after being encrypted and stored in a storage medium such as a CD-ROM, and users that satisfy prescribed conditions may be allowed to download key information for decryption from a website via the Internet. The encrypted program is then executed and installed on a computer by using the key information so as to realize the functional processing of the present invention.

The functions of the above embodiments may also be realized by a computer executing the read program. Alternatively, an OS or the like running on a computer may perform part or all of the actual processing based on the instructions of the program, with the functions of the above embodiments being realizable as a result of this processing.

Further, the program read from a recording medium may be written to a memory provided in a function expansion board inserted into a computer or a function expansion unit connected to a computer. A CPU or the like provided in the function expansion board or the function expansion unit may then perform part or all of the actual processing based on the instructions of the program, with the functions of the above embodiments being realized as a result of this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese patent application No. 2006-168120, filed Jun. 16, 2006, which is hereby incorporated by reference herein in its entirety.

What is claimed is:

1. A printing apparatus comprising:
a printing unit;
a determination unit adapted to determine whether a print resolution of the printing unit is greater than or equal to a resolution of bitmap image data included in print data received from another apparatus; and
a control unit adapted to permit printing by the printing unit of the bitmap image data included in the print data if it is determined by the determination unit that the print resolution of the printing unit is greater than or equal to the resolution of the bitmap image data, and interrupt or terminate printing by the printing unit of the bitmap image data included in the print data if it is determined by the determination unit that the print resolution of the printing unit is less than the resolution of the bitmap image data.

2. A printing apparatus comprising:
a printing unit;
a reception unit adapted to receive bitmap copy-forgery-inhibited pattern image data and document image data from another apparatus;
a determination unit adapted to determine whether a print resolution of the printing unit is greater than or equal to a resolution of the bitmap copy-forgery-inhibited pattern image data received by the reception unit; and
a control unit adapted to permit printing by the printing unit of composite image data obtained by synthesizing the bitmap copy-forgery-inhibited pattern image data and the document image data if it is determined by the determination unit that the print resolution of the printing unit is greater than or equal to the resolution of the bitmap copy-forgery-inhibited pattern image data, and interrupt or terminate printing by the printing unit of composite image data obtained by synthesizing the bitmap copy-forgery-inhibited pattern image data and the document image data if it is determined by the determination unit that the print resolution of the printing unit is less than the resolution of the bitmap copy-forgery-inhibited pattern image data.

3. The printing apparatus according to claim 2, wherein the control unit requests the another apparatus for bitmap copy-forgery-inhibited pattern image data less than or equal to the print resolution of the printing unit if it is determined by the determination unit that the print resolution is less than the resolution of the bitmap copy-forgery-inhibited pattern image data.

4. A printing apparatus comprising:
a printing unit;
a determination unit adapted to determine whether a print resolution of the printing unit is a positive integer multiple of a resolution of bitmap image data included in print data received from another apparatus; and
a control unit adapted to permit printing by the printing unit of the bitmap image data included in the print data if it is determined by the determination unit that the print resolution of the printing unit is a positive integer multiple of the resolution of the bitmap image data, and interrupt or terminate printing by the printing unit of the bitmap image data included in the print data if it is determined by the determination unit that the print resolution of the printing unit is not a positive integer multiple of the resolution of the bitmap image data.

5. A method for a printing apparatus having a printing unit, the method comprising:
determining whether a print resolution of the printing unit is greater than or equal to a resolution of bitmap image data included in print data received from another apparatus; and
permitting printing by the printing unit of the bitmap image data included in the print data if it is determined that the print resolution of the printing unit is greater than or equal to the resolution of the bitmap image data, and interrupting or terminating printing by the printing unit of the bitmap image data included in the print data if it is determined that the print resolution of the printing unit is less than the resolution of the bitmap image data.

6. A method for a printing apparatus having a printing unit, the method comprising:
receiving bitmap copy-forgery-inhibited pattern image data and document image data from another apparatus;
determining whether a print resolution of the printing unit is greater than or equal to a resolution of the bitmap copy-forgery-inhibited pattern image data received; and
permitting printing by the printing unit of composite image data obtained by synthesizing the bitmap copy-forgery-inhibited pattern image data and the document image data if it is determined that the print resolution of the printing unit is greater than or equal to the resolution of the bitmap copy-forgery-inhibited pattern image data, and interrupting or terminating printing by the printing unit of composite image data obtained by synthesizing the bitmap copy-forgery-inhibited pattern image data and the document image data if it is determined that the print resolution of the printing unit is less than the resolution of the bitmap copy-forgery-inhibited pattern image data.

7. The method according to claim 6, further comprising requesting bitmap copy-forgery-inhibited pattern image data less than or equal to the print resolution of the printing unit from the another apparatus if it is determined that the print resolution is less than the resolution of the bitmap copy-forgery-inhibited pattern image data.

8. A method for a printing apparatus having a printing unit, the method comprising:
determining whether a print resolution of the printing unit is a positive integer multiple of a resolution of bitmap image data included in print data received from another apparatus; and
permitting printing by the printing unit of the bitmap image data included in the print data if it is determined that the print resolution of the printing unit is a positive integer multiple of the resolution of the bitmap image data, and interrupting or terminating printing by the printing unit of the bitmap image data included in the print data if it is determined that the print resolution of the printing unit is not a positive integer multiple of the resolution of the bitmap image data.

9. A storage medium storing, in a computer-readable form, a computer program that realizes a method for a printing apparatus having a printing unit, wherein the computer program causes a computer to execute:
a determination step of determining whether a print resolution of the printing unit is greater than or equal to a resolution of bitmap image data included in print data received from another apparatus; and
a control step of permitting printing by the printing unit of the bitmap image data included in the print data if it is determined that the print resolution of the printing unit is greater than or equal to the resolution of the bitmap image data, and interrupting or terminating printing by the printing unit of the bitmap image data included in the print data if it is determined that the print resolution of the printing unit is less than the resolution of the bitmap image data.

10. A storage medium storing, in a computer-readable form, a computer program that realizes a control method for a printing apparatus having a printing unit, wherein the computer program causes a computer to execute:
a reception step of receiving bitmap copy-forgery-inhibited pattern image data and document image data from another apparatus;
a determination step of determining whether a print resolution of the printing unit is greater than or equal to a resolution of the bitmap copy-forgery-inhibited pattern image data received by the reception step; and
a control step of permitting printing by the printing unit of composite image data obtained by synthesizing the bitmap copy-forgery-inhibited pattern image data and the document image data if it is determined that the print resolution of the printing unit is greater than or equal to the resolution of the bitmap copy-forgery-inhibited pattern image data, and interrupting or terminating printing by the printing unit of composite image data obtained by synthesizing the bitmap copy-forgery-inhibited pattern image data and the document image data if it is determined that the print resolution of the printing unit is less than the resolution of the bitmap copy-forgery-inhibited pattern image data.

11. The storage medium according to claim 10, wherein the control step requests the another apparatus for bitmap copy-forgery-inhibited pattern image data less than or equal to the print resolution of the printing unit if it is determined that the print resolution is less than the resolution of the bitmap copy-forgery-inhibited pattern image data.

12. A storage medium storing, in a computer-readable form, a computer program that realizes a method for a printing apparatus having a printing unit, wherein the computer program causes a computer to execute:
a determination step of determining whether a print resolution of the printing unit is a positive integer multiple of a resolution of bitmap image data included in print data received from another apparatus; and
a control step of permitting printing by the printing unit of the bitmap image data included in the print data if it is determined that the print resolution of the printing unit is a positive integer multiple of the resolution of the bitmap image data, and interrupting or terminating printing by the printing unit of the bitmap image data included in the print data if it is determined that the print resolution of the printing unit is not a positive integer multiple of the resolution of the bitmap image data.
